(19) United States
(12) Patent Application Publication
(10) Pub. No.: US 2026/0308078 A1
(43) Pub. Date: Oct. 8, 2026

(54) OXIDIZED CELLULOSIC MATERIALS AND METHOD OF MANUFACTURING SAME

(71) Applicant: The Research Foundation for The State University of New York, Albany, NY (US)

(72) Inventors: Benjamin S. HSIAO, Setauket, NY (US); Ken I. JOHNSON, Saginaw, MI (US); Rasel DAS, Port Jefferson, NY (US); Grenalynn C. ILACAS, Middle Island, NY (US)

(21) Appl. No.: 19/482,968

(22) PCT Filed: Apr. 30, 2024
(86) PCT No.: PCT/US2024/026949

§ 371 Date: Nov. 10, 2025

Related U.S. Application Data
(60) Provisional application No. 63/465,561, filed on May 11, 2023.

(51) Int. Cl. C05F 5/00; B09B 3/35; B09B 3/40; B09B 3/70; C05G 5/27

(52) U.S. Cl. CPC C05F 5/002; B09B 3/35; B09B 3/40; B09B 3/70; C05G 5/27

(57) ABSTRACT

The present disclosure provides methods for treating biowaste and similar waste sources with nitric acid. Where the waste source includes plant-based fibrous materials, animal and food waste, the present methods provide for the extraction and use of nanostructured cellulose (nanocellulose) with an anionic surface charge for adsorption of cationic contaminants such as ammonium, and selective environmentally friendly methods for the functionalization of cellulosic biomass.

### GOVERNMENT RIGHTS

This invention was made with government support under grant number 2140820 awarded by the National Science Foundation. The government has certain rights in the invention.

### BACKGROUND

Separation processes are important in many industries. Membrane separation technology may be used in many separation processes. These processes include water purification, desalination, air filtration/separation, gas separation, membrane bioreactor, etc.

However, in some cases, water purification using adsorbent materials may be more desirable. The use of adsorbent materials is relatively accessible and low cost, and sometimes can outperform filtration techniques by removing dissolved particles which would otherwise be too small to remove mechanically.

Production of nanocellulose as a scaffold is important as a naturally derived and biodegradable sustainable material for broken industries such as agriculture. Processes used to produce nanocellulose require energy intensive technologies, hazardous or toxic chemicals, and unsustainable feedstocks or reagents.

Improved materials and methods for use in separation processes, including water purification, remain desirable.

### SUMMARY

The present disclosure provides methods for treating biowaste and similar waste sources with nitric acid. In aspects, the present disclosure provides methods which include contacting a biowaste source with nitric acid, optionally contacting the biowaste source and nitric acid with sodium nitrite, heating the biowaste source, the nitric acid, and the optional sodium nitrite to a temperature of from about 25° C. to about 100° C. to form a gellable nanocellulose suspension, and recovering the nanocellulose suspension.

In embodiments, the nitric acid is in a solution at a concentration from about 30% to about 50%.

In some embodiments, the ratio of nitric acid in solution to the biowaste source is from about 10:1 to 1:1.

In other embodiments, the sodium nitrite is in a solution at a concentration of from about 15% to about 70% by weight.

In embodiments, the ratio of sodium nitrite in solution to the biowaste source is from about 1:0.25 to 1:5.

In some embodiments, heating the biowaste source, the nitric acid, and the optional sodium nitrite occurs for a period of time from about 1 hour to about 24 hours.

In embodiments, the biowaste source includes cellulose.

In some embodiments, the gellable suspension includes carboxylated cellulose nanofibers.

In embodiments, the methods of the present disclosure further include contacting the biowaste source and nitric acid with sodium nitrite.

In some embodiments, the methods of the present disclosure further include pre-treating the biowaste source with an alkaline solution prior to contacting the biowaste source with nitric acid.

Where utilized, the alkaline solution may include KOH, NaOH, potassium phosphate, or combinations thereof.

In embodiments, the alkaline solution has a pH from about 8 to about 14.

In some embodiments, the methods of the present disclosure further include grinding biomass within the biowaste source prior to contacting the biowaste source with alkaline pre-treatment or nitric acid.

In some embodiments, the nanocellulose in the gelable suspension has a carboxylic acid content from about 0.1 mmol/g to about 3 mmol/g.

Fertilizers produced by the methods of the present disclosure are also provided.

### BRIEF DESCRIPTION OF THE DRAWINGS

Various embodiments of the presently disclosed membranes and methods are described herein with reference to the drawings wherein:

FIG. 1 is a flow chart depicting the steps of the general process of the present disclosure.

FIG. 2 is a diagram of a system which can be used to carry out the process of the present disclosure.

FIG. 3 is a graph depicting carboxylic acid concentration and total content plotted over the ratio of millimoles of nitrite to grams of jute used during the nitro-oxidation processes (NOP) 10, 1, and 4. All other reactions conditions were identical.

FIG. 4 is a graph depicting carboxylic acid concentration and total content plotted over the temperature used during the pulping phase of nitro-oxidation processes (NOP) 9, 1, and 13. All other reactions conditions were identical.

FIG. 5 is a graph depicting carboxylic acid concentration and total content plotted over the temperature used during the oxidation phase of nitro-oxidation processes (NOP) 2, 1, and 15. All other reactions conditions were identical.

FIG. 6 is a graph depicting carboxylic acid concentration and total content plotted over reactions using both pulping and oxidation or only oxidation using either jute or bleached jute. All other reactions conditions were identical.

FIG. 7 is a graph depicting carboxylic acid concentration and total content plotted over the quantity of nitrite used as either a solid or liquid. All other reactions conditions are identical.

FIG. 8 is a graph depicting carboxylic acid content of nitro-oxidized cellulose nanofibers (NOCNF) from different nitro-oxidation processes (NOP) plotted over their respective crystallinity indexes determined by wide-angle X-ray diffraction (WAXD).

FIG. 9 is a graph depicting Fourier transform infrared (FTIR) spectra of jute and nitro-oxidized cellulose nanofibers (NOCNF) from different nitro-oxidation processes (NOP). Peak heights at 1427 cm⁻¹ and 895 cm⁻¹ are used to calculate FTIR derived crystallinity.

FIG. 10 is a graph depicting the T (%)_{1427/895} of jute and nitro-oxidized cellulose nanofibers (NOCNF) from different nitro-oxidation processes (NOP) plotted over their respective crystallinity indexes. T (%)_{1427/895} is calculated from the quotient of the % transmittance at 1427 cm⁻¹ and 895 cm⁻¹ for each sample.

FIGS. 11A1-2-11B1-2 include graphs depicting deconvoluted wide-angle X-ray diffraction (WAXD) patterns of jute and nitro-oxidized cellulose nanofibers (NOCNF) from different nitro-oxidation processes (NOP).

FIGS. 12A1-4-12B1-4 include graphs depicting conductometric titration curves of nitro-oxidized cellulose nanofibers (NOCNF) from different nitro-oxidation processes (NOP). Points used for determining the acid curve and basic curve are shown in squares and triangles, respectively. Linear line fittings were conducted, with fitting data shown.

FIG. 13 includes graphs depicting characterization of nitro-oxidized cellulose nanofibers (NOCNF) and ammonium-loaded NOCNF indicated as NH4⁺@NOCNF via (i) Fourier transform infrared spectroscopy (FTIR) highlighting the presence of C═O and O—H stretching. (ii) Thermogravimetric analysis (TGA) plots showing the weight of NOCNF samples as a function of temperature. (iii) TGA shown as the derivative weight of NOCNF samples, more clearly indicating onset temperatures. (iv) Wide-angle X-ray diffraction (WAXD) patterns representing the crystallinity of pristine and adsorbed samples.

FIG. 14 includes images demonstrating the morphological characterization of nitro-oxidized cellulose nanofibers (NOCNF) and its respective ammonium-loaded NOCNF. (i) Atomic force microscopy (AFM) images of NOCNF and (ii) ammonium-loaded NOCNF. (iii) Transmission electron microscopy (TEM) images of NOCNF and (iv) ammonium-loaded NOCNF.

FIG. 15 includes graphs depicting adsorption data using nitro-oxidized cellulose nanofibers (NOCNF). (i) Ammonium removal plotted over the equilibrium concentration using NOCNF with various degrees of oxidation (DO). Langmuir isotherm curves drawn for each sample convey adherence to experimental data and general trends. (ii) Effect of pH on ammonium removal and zeta potential on NOCNF. Optimal adsorption capacity is observed near neutral pH conditions. (iii) Ammonium adsorption using NOCNF and zeta potential of NOCNF with increasing amounts of ammonium, shown as the molar ratio of ammonium over carboxylate content. Dashed lines drawn to facilitate the comparison of different measurements. (iv) Adsorption capacity of ammonium using TEMPO-mediated oxidized cellulose nanofibers (TEMPO-CNF).

FIG. 16 includes graphs depicting Langmuir fitting for (i) nitro-oxidized cellulose nanofibers (NOCNF) and (ii) TEMPO oxidized cellulose nanofibers (TEMPO-CNF).

FIG. 17 includes graphs depicting Freundlich fittings for (i) nitro-oxidized cellulose nanofibers (NOCNF) and (ii) TEMPO oxidized cellulose nanofibers (TEMPO-CNF).

FIG. 18 is a graph depicting nitrogen composition of tested soils over a three-week period.

FIG. 19 includes graphs depicting mass of roots, stems, and leaves for each soil treatment over a three-week period.

FIG. 20 includes graphs depicting nitrogen composition of roots, stems, and leaves for each soil treatment over a three-week period.

### DETAILED DESCRIPTION

The following detailed description of embodiments of the subject matter of the present disclosure will be made in reference to the accompanying drawings. In describing the disclosure, explanation about related functions or constructions known in the art are omitted for the sake of clearness in understanding the concept of the present disclosure to avoid obscuring the recited subject matter with unnecessary detail.

The ever-growing population and subsequent need to feed humanity is causing a crisis in the search for fresh potable water and sustainable food production. Nutrient pollution, an inevitable consequence of agricultural and residential wastewater leaching into groundwater reservoirs, rivers, and oceans, has disrupted the nitrogen cycle and the means by which fresh water is acquired. In one aspect of nutrient pollution, ammonium fertilizer is heavily applied in industrial agriculture in both developing and developed countries, where the limiting consumption in crop growth and thus inevitable leaching has created varying environmental challenges due to nutrient pollutant.

Currently, these nutrient pollutants are not managed properly in both agricultural and wastewater treatment sectors. For example, many wastewater plants in the United States are not designed for nutrient removal, and retrofitting treatment plants may not be feasible. Current methods of ammonium removal include electrochemical, biological nitrification de-nitrification, adsorption (activated carbon and zeolites), and reverse osmosis, which are typically expensive to operate. The consequences of ammonium pollution in waterbodies include eutrophication, which is the result of unsustainable growth in algal blooms causing the depletion of dissolved oxygen in water, and potential death of marine life.

The present disclosure provides methods for treating various biowaste with nitric acid and the obtained product i.e., oxidized cellulose, can be used for wastewater treatment. Specifically, the waste source includes plant-based fibrous materials, the present methods provide for the extraction and use of nanostructured cellulose with an anionic surface charge for adsorption of cationic contaminants such as ammonium, and selective environmentally friendly methods for the functionalization of cellulosic biomass.

In embodiments, any biowaste to be treated, for example agricultural waste, food waste, animal waste, and the like, may be contacted with nitric acid. Sodium or potassium nitrite may be optionally added to the system. To accelerate the process, adding metal-oxides-based catalysts can be effective. The resulting oxidized cellulose and effluent formed by this process may be applied as an anionic scaffold, a remediation material, or to plants as a fertilizer.

Whether the process produces a nanocellulose fertilizer, or functionalized cellulose nanofibers having an anionic surface charge, sometimes referred to herein as nitro-oxidized cellulose nanofibers (NOCNF), will be dependent on the biomass being treated. For example, for forming nanocellulose fertilizers, the biomass to be treated may include animal waste, including chicken manure, horse manure, cow manure, and the like, as well as food waste, including kitchen waste, spent coffee grounds, pomace, and the like.

For forming the NOCNF, the starting biomass should be a fibrous plant-based biomass. Examples of such starting biomasses include, but are not limited to, cotton, jute, bagasse, spent grains, palm, coconut, and the like. In embodiments, the NOCNF may also be in the form of a supportive suspension, suitable for application to plants as a fertilizer, or as a water remediation material.

In other embodiments, the present disclosure treats wastewaters containing fibrous materials, such as cellulose. Where the fluid to be treated includes fibrous materials, including cellulose, the fibers may be functionalized. Cellulose can be functionalized by surface modifications including carboxymethylation, carboxylation, sulfonation, and phosphorylation, or grafting with other molecules/compounds or external agents like nanoparticles and their ions. In aspects of the present disclosure, carboxylation of jute fibers was performed by the nitro-oxidation process (NOP) to extract high charge density nitro-oxidized cellulose nanofibers (NOCNF). Nitro-oxidation is a method to produce carboxylated cellulose nanofibers (CNF) from raw biomass ranging from wood to agriculture residues in one or two-steps. NOCNF has a carboxylate ion functional group on the C6 carbon and may possess up to one carboxylic group per anhydroglucose unit (AGU).

The subsequent oxidation process by addition of sodium nitrite yields carboxylic acid groups on the C6 position of the cellulose surface. The carboxylic acid content, product yield, and crystallinity index is quantified to assess the effectiveness of the NOP.

In aspects, the nitro-oxidation process (NOP) generates nitro-oxidized cellulose nanofibers (NOCNF) as adsorbents, and/or coagulants/flocculants. One advantage of carboxylated cellulose nanofibers (CNF) is their biocompatibility and biodegradability. CNF, while potentially regeneratable, can be applied to soil.

Previous methods using NOP for the extraction and oxidation of cellulose use 65% nitric acid, which can be challenging in regards to small scale manufacturing due to toxic acid handling.

In accordance with the present disclosure, low concentrations of nitric acid are used in the NOP process, while using the same volume. In an effort to use reagents more effectively, reactions are separated into pulping and oxidation steps. Where pulping is conducted with nitric acid to remove some lignin and hemicelluloses, oxidation occurs upon addition of sodium nitrite. The effects of different parameters, such as starting biomass, acid concentration, temperature, reaction time and quantity of sodium nitrite were examined.

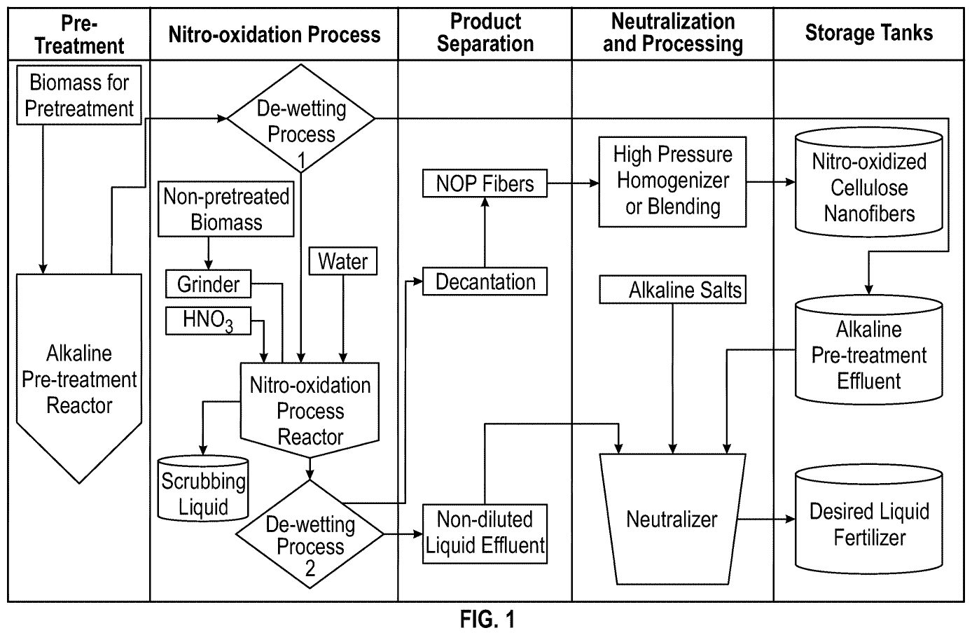

The general process of the present disclosure is depicted in FIG. 1. The biomass/wastewater to be treated may be optionally pretreated with an alkaline solution. Suitable solutions for this pretreatment include, for example, NaOH, KOH, potassium phosphate, combinations thereof, and the like. The pH of the solution used for this alkaline pretreatment may be from about 8.0 to about 14.0, in embodiments from about 10.0 to about 12.0. The pretreated biomass may then be dried, referred to as “De-wetting process 1” in FIG. 1.

Any biomass not subject to the alkaline pretreatment may separately be prepared for the process of the present disclosure by first subjecting the biomass to a process for breaking down the size of the particles/fibers making up the biomass, such as placement in a grinder. The ground biomass and optional alkaline pretreated biomass may then be placed in a reactor and combined with nitric acid, oxidizing agent, and water.

The biomass treated with nitric acid may then be dried, referred to as “De-wetting process 2” in FIG. 1. Any fibrous materials may then be separated from the liquid effluent. The liquid effluent may be contacted with a neutralizer, such as KOH, NaOH, NH₄OH, (NH₄)₃PO₄, K₃PO₄, combinations thereof, and the like, to form a liquid fertilizer composition suitable to treat plants. In addition, where the biomass has been pre-treated as described above with an alkaline solution, the effluent obtained after “De-wetting Process 1” may be combined with the liquid effluent obtained after “De-wetting Process 2” and the neutralizer in forming the liquid fertilizer. The fibrous materials may be placed in a high pressure homogenizer or blending, resulting in the formation of macro, micro or nanoscale CNF (i.e. NOCNF).

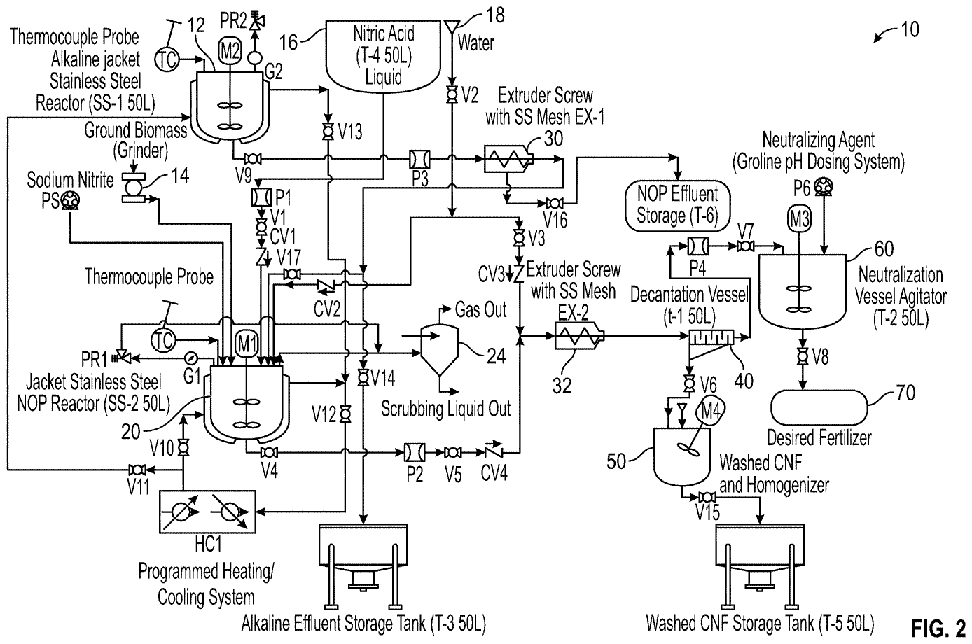

A system 10 suitable for carrying out the process of the present disclosure is depicted in FIG. 2. As generally depicted in FIG. 2, the system 10 may include the various reactors, grinders, holding tanks, pumps, heating components, storage tanks, etc., for carrying out the general process depicted in FIG. 1. The system 10 includes a reactor 12 for conducting the alkaline pretreatment of any biomass. Grinder 14 may be used for breaking down some of the biomass. Any ground biomass and alkaline pretreated biomass may then be added to reactor 20. A tank 16 having nitric acid and a tank 18 having water may be connected to reactor 20 for adding those materials to reactor 20. Scrubbing liquid from the reactor 20 may be collected in tank 24. The solid and liquid effluent mixture from the reactor 12 may pass through extruder 30 and then pass to reactor 20. The solid and liquid effluent mixture from the reactor 20 may pass through extruder 32. From extruder 32, the solid material passes into decantation vessel 40 (optional), where the NOCNF are passed into reactor 50 for washing and homogenizing or blending. The liquid effluent from the decantation vessel passes into reactor 60 for neutralization and formation of liquid fertilizer, which is collected in fertilizer storage tank 70.

The nitric acid used in the processes of the present disclosure may be in a solution at a concentration of from about 15% to about 70%, in embodiments from about 25% to about 50%. The volume of nitric acid solution used to treat the biowaste will, of course, depend upon the volume of biowaste to be treated. In general, the ratio of nitric acid solution to biowaste being treated may be from about 1:0.5 to about 1:20, in embodiments about 1:14.

Optionally, sodium nitrite may be further added to the wastewater being treated. Where utilized, the sodium nitrite may be in a solution at a concentration of from about 1% to about 10%, in embodiments from about 3% to about 7%. The volume of sodium nitrite solution used to treat the biowaste will, of course, depend upon the volume of biowaste to be treated. In general, the ratio of sodium nitrite solution to biowaste being treated may be from about 1:0.25 to about 1:5, in embodiments about 1:2.

The nitric acid and optional sodium nitrite may be contacted with the biowaste at a temperature from about 25° C. to about 100° C., in embodiments from about 30° C. to about 80° C., in yet other embodiments from about 40° C. to about 60° C. The nitric acid and optional sodium nitrite may be contacted with the biowaste for a period of time from about 1 hour to about 24 hours, in embodiments from about 2 hours to about 12 hours, in yet other embodiments from about 3 hours to about 9 hours.

Where the biowaste source does not include fibrous materials, the result of the above processes/treatments of biowaste with nitric acid and optional sodium nitrite is a liquid biowaste effluent. The effluent, which includes nutrients such as nitrates, may be used as a fertilizer.

Where the biowaste source includes fibrous cellulosic materials, the process of the present disclosure produce biodegradable and sustainably sourced charged nanocellulose extracted from the fibers within the biowaste source. The charged nanocellulose may be functionalized nanofibers or, in some embodiments, a gellable suspension. Ionic gelation of the nanocellulose suspension produces a hydrogel. This hydrogel may have a viscosity which can be characterized by rheometer. The modulus of complex viscosity (|η*|) could be measured at different frequencies. The storage modulus (G′), and the loss modulus (G″) could be further calculated from η* and can be used to illustrate the gel's ability to store energy elastically and dissipate energy as heat. By comparing the two parameters G′ and G″, one can define whether the samples is “gel-like” (solid-state) when G′>G″ or liquid state when G′<G″.

In accordance with the present disclosure, the NOCNF produced by the disclosed processes may be used to remediate ammonium pollution followed by recycling the ammonium-loaded NOCNF as a fertilizer. NOCNF inserts itself in the middle of the cycle by adsorbing ammonium right after pollutants are created. The ammonium is captured with NOCNF before its conversion to more difficult forms of nitrogen for removal such as negatively charged nitrites and nitrates. For example, a very ubiquitous derivative of ammonium comes in the form of urea, which is a major component of human urine. This urea decomposes into cationic ammonium, which can then be removed using the anionic NOCNF produced by the processes of the present disclosure.

The resulting nanocellulose extraction is part of a zero-waste nitro-oxidation process (NOP) using a relatively low concentration of nitric acid (30-50%). This process partially delignifies fibrous cellulosic materials to yield nanostructured microfibers by way of dissolving some amorphous components (hemicelluloses and lignin). Adsorption for the capture of ammonium is simple, efficient, economical, scalable, and the captured ammonium impurities in a bio-scaffold can be used as a plant fertilizer, for example, for direct ammonium adsorption.

A gellable suspension including NOCNF produced by the processes of the present disclosure from the treatment of fibrous biowaste sources may have a carboxylic acid content from about 0.1 mmol/g to about 3 mmol/g, in embodiments from about 0.2 to about 1.5 mmol/g, in other embodiments from about 0.5 to about 1.3 mmol/g.

As noted above, the gellable suspensions produced as a result of the disclosed processes may be utilized as fertilizers. Nanocellulose derived from the nitro-oxidation process provides a relatively accessible, low cost, and an environmentally friendly methodology for the upcycling of biowaste into valuable materials for use in a myriad of applications including water purification, or fertilizers for agriculture. The process of the present disclosure provides a cost-effective, simple, environmentally friendly process to treat wastewater and similar waste sources for future use as fertilizers.

### EXAMPLES

The materials used in these examples included jute fibers obtained from Bangladesh. Nitric acid (65%), sodium nitrite (97%), ammonium chloride (98%), and hydrochloric acid (1.0 N) were purchased from Sigma Aldrich. Sodium bicarbonate was purchased from Fischer Scientific. Sodium hydroxide (99%) was purchased from Macron Fine Chemicals. Chemicals were used without any further purification. General purpose soil was purchased from ProMix. Soybean seeds were purchased from Seed Ranch.

### Example 1

Jute fibers were cut down to 5 cm and then passed through a grinder with a 2 mm grating. 10 grams of ground jute was placed in a 3-liter round bottom flask with 140 ml of nitric acid of various concentrations, listed in Table 1 below.

The fibers were allowed to soak before initiating magnetic stirring of approximately 200 rotations per minute (rpm). Once stirring was stabilized after a couple minutes, various amounts of sodium nitrite were added and the temperature of the oil bath was set according to Table 1 below.

Upon addition of sodium nitrite, the round bottom flask was sealed with a glass stopper and parafilm. If no sodium nitrite was added, the round bottom flask was also stoppered, after addition of nitric acid. The reaction was carried over a given amount of time, according to Table 1 below. After the specified amount of time, the oil bath was turned off and the round bottom flask was carefully unsealed, allowing excess gases to passively evacuate the round bottom flask while maintain stirring. The reaction was then terminated by pouring 1 liter of deionized water into the round bottom flask to significantly reduce the reactivity of the reagents. The suspension was poured into a beaker and the suspended solids are allowed to settle. The supernatant was decanted and replaced with fresh deionized water. This decantation process was repeated until the pH of the supernatant reached 2.

The fibers were then washed using a 40 μm filter paper and deionized water until the filtrate achieves a stable conductivity.

### Example 2

Bleached jute fibers were used as a comparison for using pretreated fibers. Jute fibers were cut down to 5 cm and then passed through a grinder with a 2 mm grating. Approximately 30 grams of ground jute are suspended in a 1% (w/v) sodium chlorite solution in 0.1M acetate buffer at pH 5. The suspension was stirred under heating at 65° C. for 3 hours. Fibers were vacuum filtered and rinsed with deionized water. The procedure was repeated 3 times. Final washing was conducted to ensure effluent was similar to the conductivity of deionized water. Fibers were then oven dried at 50° C. for 24 hours in a large glass dish. Dried bleached fibers were passed through a grinder to powder the coalesced fibers.

Table 1 below summarizes the reaction conditions for the nitro-oxidation reactions carried out following the procedures of Examples 1 and 2. The Nitro-oxidation reactions are numbered 1-15. Typically, reactions were conducted in two phases, consisting of a pulping phase and an oxidation phase. Cells in bold indicate how they differ from NOP 1. Cells with (1) indicate the sodium nitrite was added as a solution over 1 hour using the minimum amount of water required to dissolve the sodium nitrite. NOP 14 has a (l)*, meaning that the sodium nitrite solution was added over 3 hours.

TABLE 1

| | nitric | Biomass | Temperature | | sodium | | Temperature | |
|---|---|---|---|---|---|---|---|---|
| NOP | acid | (10 | 1 (° C.) | Time 1 | nitrite | | 2 (° C.) | Time 2 |
| (#) | (%) | grams) | (Pulping) | (hours) | (grams) | | (oxidation) | (hours) |
| 1 | 30 | jute | 50 | 3 | 9.6 | | 50 | 6 |
| 2 | 30 | jute | 50 | 3 | 9.6 | | 25 | 6 |
| 3 | 15 | jute | 50 | 3 | 9.6 | | 50 | 6 |
| 4 | 30 | jute | 50 | 3 | 14.4 | | 50 | 6 |
| 5 | 30 | bleached | 50 | 3 | 9.6 | | 50 | 6 |
| | | jute | | | | | | |
| 6 | 30 | jute | 50 | 9 | 9.6 | | — | — |
| 7 | 30 | bleached | 50 | 9 | 9.6 | | — | — |
| | | jute | | | | | | |
| 8 | 30 | jute | 50 | 9 | — | | — | — |
| 9 | 30 | jute | 25 | 3 | 9.6 | | 50 | 6 |
| 10 | 30 | jute | 50 | 3 | 3.8 | | 50 | 6 |
| 11 | 30 | jute | 50 | 3 | 9.6 | (l) | 50 | 6 |
| 12 | 30 | jute | 50 | 3 | 19.2 | (l) | 50 | 6 |
| 13 | 30 | jute | 60 | 3 | 9.6 | | 50 | 6 |
| 14 | 30 | jute | 50 | 3 | 19.2 | (l)* | 50 | 6 |

| | | | | | | | |
|---|---|---|---|---|---|---|---|
| 15 | 30 | jute | 50 | 3 | 9.6 | 60 | 6 |

### Characterization of NOCNF Produced in Examples 1 and 2

Typically, 270 grams of 0.1 wt. % NOCNF suspension was prepared from the stock NOCNF suspension. The pH of the suspension was adjusted to pH 2.5 using dilute hydrochloric acid. The suspension was then titrated with 0.05 M sodium hydroxide in 1 ml increments until reaching a pH of 10. More dilute solutions of sodium hydroxide could be used to achieve better resolution. Regardless, it is important to measure the pH of the titrant, rather than using the mass of sodium hydroxide, to calculate concentration. This is because sodium hydroxide is hydroscopic, but pH meters can be accurately calibrated if using fresh reagents. The conductivity of the sample was measured and plotted over volume of titrant. The resulting graph should have three linear curves. From volume 0 to V₁, adding titrant should decrease the conductivity up until a certain volume. This certain volume is designated as V₁. This is a result of neutralizing the free acid in the suspension which is present due to adding an excess amount of acid relative to the carboxylic acid content. After V₁, adding additional titrant will not noticeably change the conductivity of the suspension, since doing so would neutralize protons bound to the carboxylic acid groups. This is true to a certain volume, and that volume is designated as V₂. After this volume, additional titrant introduces free hydroxide, which will increase the conductivity. Because hydronium is more conductive than hydroxide, it is common to observe a steeper descent in conductivity, followed by a milder increase. The carboxylic acid concentration can be calculated using equation 1.

$$\frac{mmol carboxylic acid}{g NOCNF ( s )} = \frac{( {V}_{2} - {V}_{1} ) \times {C}_{t}}{m} \qquad ( 1 )$$

Where Cₜ represents the concentration of the titrant. The numerator is typically converted in to mmols. The m represents the mass of solid NOCNF, which can be calculated by first converting the weight percent (wt. %) of the suspension into a fraction by dividing the wt. % by 100, typically as mass of solid NOCNF over the mass of suspension. The mass was then quantified by multiplying by the mass of original suspension used before dilution. The final value represents the carboxylic acid content in mmols of carboxylic acid per gram of solid NOCNF.

Titrant concentrations lower than 0.03 M were used to generate more data points in the neutral zone, because of the low carboxylic acid content of these samples. Furthermore, all samples were titrated using an auto-burette, which can dose in 0.05 ml increments. The combination of lower titrant concentration and lower titrating volume helped to increase the number of data points generated in the neutral zone.

In general, a linear fitting was used with acid and base curves to determine at which volume the transitions occur, and these linear fits should have a good R-squared value, typically 0.9-0.99. One issue with this method is considering how many points are incorporated in the linear fit. Acid curves can be relatively long, sometimes consisting of more than 50 points. Considering the neutral curve can only be 4 points, it is possible to incorporate the entirety of the neutral curve while maintaining an R² value of 0.99, because there is such an excess of data in the acid curve. In this study, both acid and base curves were restricted to 10 points each and an R-squared value of 0.99, to induce good sensitivity to transition points.

### Fourier Transform Infrared Spectroscopy

Fourier transform infrared spectroscopy (FTIR) was recorded on a Nicolet iS10 FT-IR Spectrometer by Thermo Scientific using attenuated total reflectance (ATR) mode. 16 scans were averaged at a resolution of 4. The instrument was equipped with a DTGS KBr detector, KBr beam splitter, IR source, Smart iTR accessory, and diamond window. Samples were generally measured from 400-4000 cm⁻¹.

### Wide-Angle X-Ray Diffraction

A MiniFlex from Rigaku was used to measure and record wide-angle X-ray diffraction (WAXD) patterns. The samples were measured from 5 degrees to 45 degrees, measured in steps of 0.02 degrees, and a speed of 5 degrees per minute. The scan axis is set was set to theta/2-theta, in continuous mode, and intensity measured in counts per second (CPS). The voltage and current were set to 40 kV and 15 mA, respectively, using Cu Kα radiation. An incident side and receiving side soller slit of 5.0 degrees along with an incident-beam divergence-limiting slit of 1.250 degrees were used.

### Effect of Reaction Conditions on Carboxylic Acid Content

Table 1 above provides all of the tested reaction conditions, where each experiment was indexed as NOP (#). The reaction conditions were split into two parts, where nitric acid, biomass, temperature 1, and time 1 indicate the reaction conditions for pulping the specified biomass. Typically, samples are pulped with 30% nitric acid, using 10 grams raw jute, at 50° C., for 3 hours. The second part, shown as sodium nitrite, temperature 2, and time 2, represent the oxidation step. Typically, reactions use 9.6 grams sodium nitrite, at 50° C., and 6 hours. Some special variations include not using any sodium nitrite, or using sodium nitrite dissolved in water.

Table 2 below summarizes the conductometric titration data used to calculate the carboxylic acid content of all samples, and Table 3 below summarizes the data collected.

TABLE 2
Conductometric titration data used to calculate
the carboxylic acid content of samples.

| | | | | | Carboxy. |
|---|---|---|---|---|---|
| | NaOH vol. | NaOH con. | NOP | NOP Sus. | Content |
| NOP | (ml) | (mols/L) | wt. % | (grams) | (mmol/g) |
| 1 | 0.800 | 0.02455 | 0.0671 | 270.0 | 0.108 |
| 2 | 0.600 | 0.02455 | 0.1158 | 270.6 | 0.047 |
| 3 | 0.650 | 0.02455 | 0.1264 | 270.3 | 0.047 |
| 4 | 0.850 | 0.02455 | 0.0882 | 270.0 | 0.088 |
| 5 | 2.50 | 0.01690 | 0.1642 | 283.5 | 0.091 |
| 6 | 1.50 | 0.02455 | 0.1171 | 270.0 | 0.117 |
| 7 | 2.60 | 0.01690 | 0.1473 | 281.1 | 0.106 |
| 8 | 0.200 | 0.02455 | 0.0927 | 268.5 | 0.020 |
| 9 | 1.25 | 0.02455 | 0.1190 | 270.0 | 0.096 |
| 10 | 0.750 | 0.02455 | 0.1121 | 270.0 | 0.061 |
| 11 | 0.950 | 0.02455 | 0.1149 | 270.0 | 0.075 |
| 12 | 1.10 | 0.02455 | 0.1140 | 270.0 | 0.088 |
| 13 | 1.45 | 0.02455 | 0.0973 | 270.0 | 0.136 |
| 14 | 1.40 | 0.01690 | 0.1292 | 275.6 | 0.066 |
| 15 | 0.900 | 0.02455 | 0.0694 | 270.0 | 0.118 |

TABLE 3
Summary of the data gathered for each sample. Product yield
is calculated as isolated mass over starting mass.

| | Carboxylic | | | |
|---|---|---|---|---|
| | Acid Content | Product | Total | |
| | (CC) | Yield | CC | Crystallinity |
| NOP # | (mmol/g) | (%) | (mmols) | Index (%) |
| 1 | 0.108 | 34.15 | 0.37 | 63.24 |
| 2 | 0.047 | 50.70 | 0.24 | 57.57 |
| 3 | 0.047 | 54.98 | 0.26 | 54.84 |
| 4 | 0.088 | 41.49 | 0.36 | 58.5 |
| 5 | 0.091 | 72.09 | 0.65 | 62.83 |
| 6 | 0.117 | 49.39 | 0.58 | 57.74 |
| 7 | 0.106 | 69.47 | 0.74 | 60.83 |
| 8 | 0.020 | 38.73 | 0.08 | 58.90 |
| 9 | 0.096 | 55.34 | 0.53 | 57.15 |
| 10 | 0.061 | 43.43 | 0.27 | 56.94 |
| 11 | 0.075 | 52.04 | 0.39 | 56.31 |
| 12 | 0.088 | 52.47 | 0.46 | 56.48 |
| 13 | 0.136 | 49.36 | 0.67 | 56.93 |
| 14 | 0.066 | 38.90 | 0.26 | 56.39 |
| 15 | 0.118 | 30.12 | 0.36 | 65.31 |
| Jute | — | — | — | 53.78 |

NOP 1 served as a baseline, which other reactions were compared with. NOP 1 used 30% nitric acid, 10 grams jute, stirred at 50° C. for 3 hours for pulping. For oxidation, NOP 1 used 9.6 grams sodium nitrite at 50° C. for 6 hours. All other reactions only changed one of these experimental parameters, generally in either a positive or negative degree. The bold text in Table 1 indicates how they differ from NOP 1. NOP 1 has 0.108 mmols of carboxylic acid per gram of solid.

NOP 2 used a lower oxidation temperature of 25° C., compared to NOP 1. The resulting carboxylic acid content of 0.047 mmols/g is slightly less than half of that in NOP 1, indicating the relationship between the reaction kinetics and temperature.

NOP 3 used 15% nitric acid in the pulping phase, which is half the concentration used in NOP 1 or NOP 2. Similarly, the carboxylic acid content was also 0.047 mmol/g. These experiments helped confirm the synergistic effects of both nitric acid and sodium nitrite, such as the reaction of nitric acid with nitrous acid, generating the nitrosonium ion, which is suspected to be the oxidizing agent in the NOP.

NOP 4 used 14.4 grams of sodium nitrite, which is 50% more sodium nitrite used in NOP 1-3. Instead of an increase in carboxylic acid content, the content was measured to be 0.088 mmol/g. It should be expected that the carboxylic acid content should increase, instead it has decreased by approximately 19% relative to NOP 1. This clearly indicated the relative concentration of nitric acid and sodium nitrite was important, considering if too much nitrite is converted to nitrous acid, there would not be sufficient nitric acid to generate nitrosonium ions.

NOP 5 was the first of two reactions testing the effects of using bleached jute in place of raw jute. Bleached jute is bright white in color and expected to have a lower hemicelluloses and lignin content. Bleached jute was used instead as an alternative cellulosic biomass in an effort to reduce changing variables by using cellulose from a different plant biomass. Reaction conditions of NOP 5 were exactly the same as NOP 1, but used bleached jute. Carboxylic acid content was 0.091 mmol/g, less than NOP 1. This was likely because the amount of carboxylic acid was spread over a greater mass of cellulose, considering the bleached jute should contain less hemicelluloses and lignin, and more cellulose to oxidize. Whereas in NOP 1, some of the jute was dissolved, and the remaining jute is oxidized. Or, some amorphous celluloses, hemicelluloses, and lignin were oxidized, but also dissolved and lost during washing.

NOP 6 did not spend a significant amount of time in the pulping phase, instead sodium nitrite was added immediately after the addition of nitric acid. This resulted in the second highest carboxylic acid content in the study of 0.117 mmol/g.

NOP 7 used bleached jute and is an analogue to NOP 6, where neither reaction had any considerable pulping phase, instead sodium nitrite was added immediately after nitric acid. Similarly, NOP 7 had a higher carboxylic acid content (0.106 mmol/g) than NOP 5 (0.091 mmol/g), indicating the longer oxidation time increased the carboxylic acid content. Oxidation time was longer because the pulping phase was skipped, meaning the sodium nitrite was exposed to jute for the full 9 hours.

NOP 8 used no sodium nitrite, to investigate the effects of just nitric acid through a 9-hour pulping phase. As expected, the carboxylic acid content is low at 0.020 mmol/g. NOP 8 had a crystallinity index of 58.9% which was higher than that of jute, at 53.78%.

NOP 9 used a reduced pulping temperature of 25° C. There was only a slightly decreased carboxylic acid content of 0.096 mmol/g compared to 0.108 mmol/g in NOP 1. It was expected that by reducing the temperature during the pulping phase, more effective acid would be left for oxidation.

NOP 10 used 3.8 grams of sodium nitrite, which was 60% less than the amount used in NOP 1. The carboxylic acid content of 0.061 mmol/g was lower than NOP 1 (0.108 mmol/g), but about 50% higher than samples from reactions using a pulping temperature of 25° C. or using 15% nitric acid.

NOP 11 was oxidized with 9.6 grams of sodium nitrite, as typical, but dissolved in 12 grams of water and added to the round bottom flask over the course of 1 hour using a syringe pump. Carboxylic acid content was 0.075 mmol/g, lower than NOP 1 (0.108 mmol/g), which used solid sodium nitrite. NOP 12 doubled the amount of sodium nitrite to 19.2 grams, also dissolved in water and dispersed via a syringe pump over 1 hour. Carboxylic acid content was measured to 0.088 mmol/g, a small increase relative to the amount of additional sodium nitrite added.

One observation was the amount of apparent NOx gas between the two types of reactions. The intensity of brown gas in reactions using dissolved sodium nitrite appeared to be less, from a qualitative perspective, at all points throughout the run time of the reaction. When adding solid sodium nitrite, there was an immediate release of gas once the salt made contact with the acid, and a strong haze remained in the round bottom flask. This was in contrast to adding dissolved sodium nitrite, where no such gas evolution was observed, and the observed haze was relatively subdued.

NOP 14 was similar to NOP 12, except 19.2 grams of sodium nitrite dissolved in water was pumped into the round bottom flask over 3 hours, rather than 1 hour.

NOP 13 had a pulping temperature of 60° C., and the highest carboxylic acid content was observed at 0.136 mmol/g.

NOP 15 had an oxidation temperature of 60° C., with only a slightly increased carboxylic acid content compared with NOP 1.

### Effect of Reaction Conditions on the Total Carboxylic Acid Content

The carboxylic acid content multiplied by the product yield reflects both the effectiveness of oxidation and product yield. The trend of carboxylic acid content per gram and total carboxylic acid content follows the same pattern, except for NOP 9, NOP 11, and both reactions using bleached jute.

NOP 9 used a pulping temperature of 25° C., whereas NOP 1 used 50° C., and both used the same oxidation temperature of 50° C. NOP 9 had a total carboxylic acid content of 0.5285 mmols, compared to NOP 1 with 0.3702 mmols. NOP 9 had a lower carboxylic acid content (0.096 mmol/g) than NOP 1 (0.108 mmol/g). Although the carboxylic acid contents are similar, the total carboxylic acid content for NOP 9 was much higher. NOP 9, using a pulping temperature of 25° C., may reduce the amount of jute that dissolved. When adding sodium nitrite, the sodium nitrite may react with the nitric acid and cut the effective strength of the acid to dissolve the jute.

This may be further illustrated when compared to the oxidation only reaction NOP 6, where sodium nitrite was added immediately after nitric acid, then heated to 50° C. The oxidation time for NOP 6 was 3 hours longer, but the product yield was comparable between NOP 6 (49.39%) and NOP 9 (55.34%), where the slightly lower yield could be attributed to a longer reaction time.

NOP 11 was oxidized with sodium nitrite solution, and while having a lower carboxylic acid content of 0.075 mmol/g, compared to 0.108 mmol/g for NOP 1, the total carboxylic acid content (0.3912 mmols) was greater than that measured in NOP 1 (0.3702 mmols).

Both reactions using bleached jute, NOP 5 and NOP 7, had the highest total carboxylate acid content of 0.6543 mmols and 0.7372 mmols respectively, with the exception of NOP 13, which had a higher content than NOP 5. Because the reactions were conducted with bleached jute, there should be less hemicelluloses and lignin to pulp. As a result, less of the oxidized jute was likely to be dissolved and subsequently lost during washing.

NOP 13 had the highest carboxylic acid content of 0.136 mmols/g and the second highest total carboxylic acid content of 0.6687 mmols. Using a higher pulping temperature of 60° C. not only increased the carboxylic acid content, but also the overall yield. An explanation in the case of NOP 13 may be related to the glass transition point (T_{g}) of lignin. Pulping literature refers to the T_{g} of lignin as a sudden change in the apparent softness of the material. Amorphous polymers, such as lignin, can have a T_{g}, which is a temperature range at which the material transitions from a glassy state to a more rubbery state. The effective T_{g} in the instance of lignin can be lowered while in the presence of water. Water which is absorbed into lignin can act as a low molecular weight diluent, acting as a plasticizer and lowering the T_{g}. The literature reported T_{g} for hemicelluloses is 40° C. and 50-100° C. for lignin. It is possible that a higher pulping temperature of 60° C. could be sufficient to reach the T_{g} of lignin in the NOP 13, and dissolve the more accessible lignin rather than the cellulose. This may result in the overall higher product yield observed.

Other samples with comparable product yields of 49.4% were NOP 2, NOP 3, NOP 6, and NOP 9, but they all had lower carboxylic acid contents. The above-mentioned reactions all in some regard reduce the effective strength of nitric acid, either by reducing oxidation temperature, reducing nitric acid concentration, reacting sodium nitrite with nitric acid earlier in the process, or reducing pulping temperature, respectively. NOP 13 differentiated itself from these reactions by using nitric acid more effectively, by reacting with the more accessible lignin, then using the remaining acid to oxidize the cellulose.

### Effects of Sodium Nitrite Composition

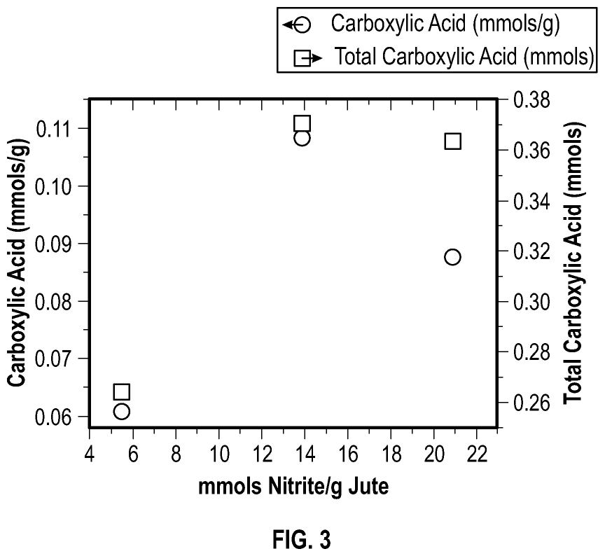

FIG. 3 displays the carboxylic acid concentration and total content plotted over the ratio of millimoles of nitrite to grams of jute used for NOP 10, 1, and 14. All other reaction conditions were identical. The trend in both carboxylic acid content and total content is similar when increasing the ratio of millimoles nitrite to grams cellulose, from 5.5 to 13.9. As the relative amount of nitrite was further increased, carboxylic acid content decreased relatively more than total content.

### Effects of Pulping Temperature

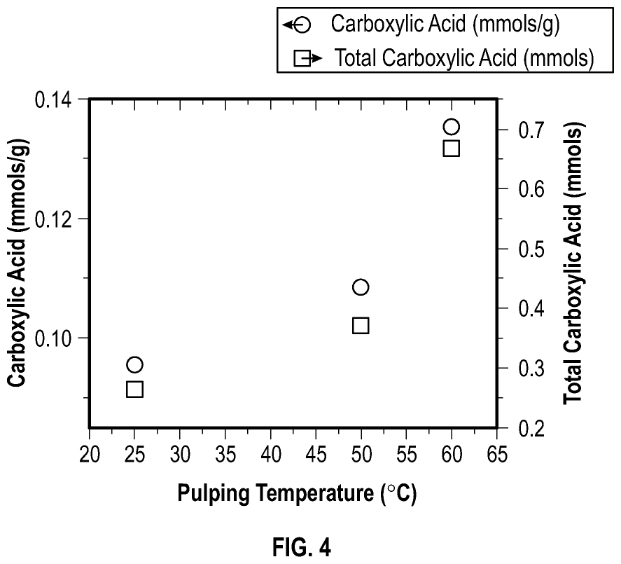

FIG. 4 illustrates the trend of carboxylic acid concentration and total content plotted over the pulping temperature used for NOP 9, 1, and 13. All other conditions were identical. Both carboxylic acid concentration and total content increased with temperature, with a 40% increase from 25-50° C. and 80% increase from 50-60° C. Because pulping was conducted before oxidation, changing parameters relating to pulping, such as temperature, essentially changed the starting material. Using a temperature of 25° C., the composition of jute was relatively closer to that of the original jute, compared to when using 60° C. It is believed the “starting material” for oxidation at 60° C. is a significantly delignified jute biomass, given that studies indicate the T_{g} of lignin is in the range of 50-100° C., and a pulping temperature of 60° C. may increase interaction with nitric acid. When initiating oxidation, more of the cellulose surface may be exposed for oxidation.

### Effects of Oxidation Temperature

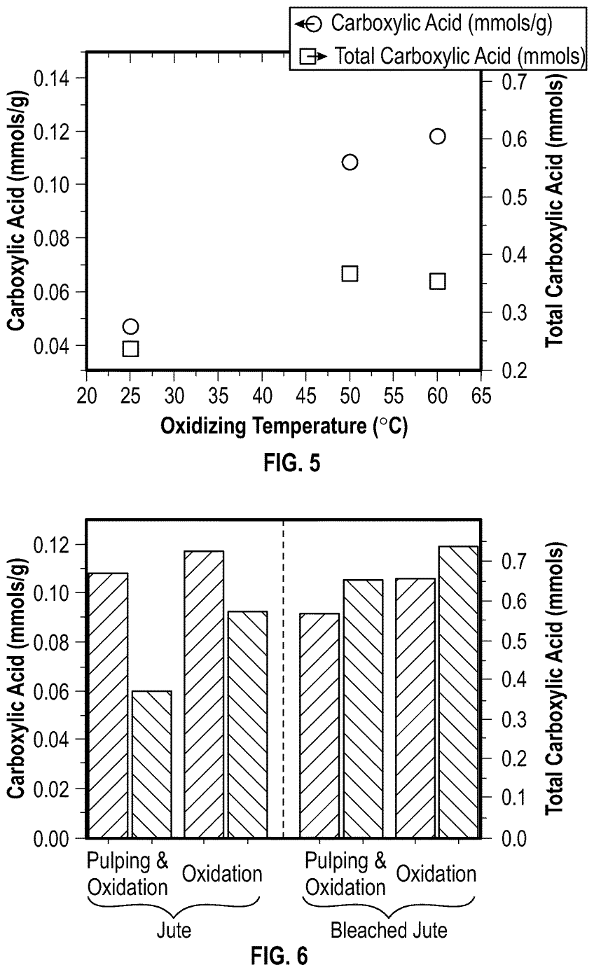

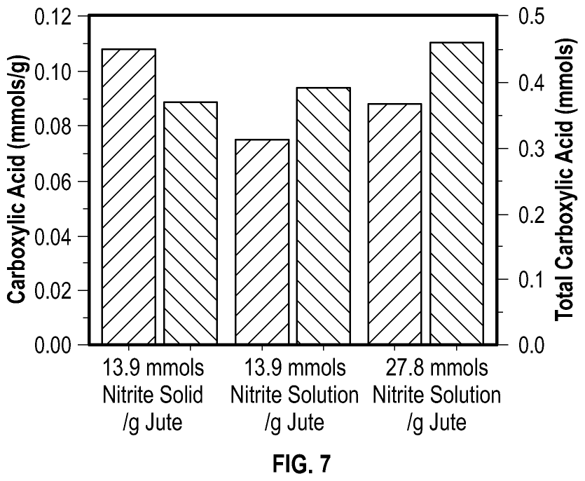

FIG. 5 conveys the trend of carboxylic acid concentration and total content plotted over the oxidation temperature used for NOP 2, 1, and 15. All other conditions were identical. Unlike with pulping, all starting samples were essentially identical at the start of the oxidation phase. While the increasing oxidation temperature does increase the carboxylic acid content as expected, total content decreases very slightly, reflecting the cost of lower product yield. After pulping at 50° C. for 3 hours, the increase to 60° C. for oxidation did not have the same benefits as conducting the pulping at 60° C.

### Relative Performance in Pulping and Oxidation Methods in Jute and Bleached Jute

FIG. 6 compares carboxylic acid concentration and total content plotted over reactions using both pulping and oxidation or only oxidation using either jute or bleached jute. All other reactions conditions were identical. Both metrics increase when conducting oxidation only, indicating two points. The greater exposure time to sodium nitrite increased oxidation, and extended exposure to nitric acid at 50° C. may degrade more of the starting material.

The study was also conducted on bleached jute fibers, to elucidate the effects on a starting material with greater cellulose content. The same conclusion was found when using bleached jute, that oxidation was more effective than pulping and oxidation. Interestingly, the greater total carboxylic acid content when using bleached jute indicated the starting materials' greater resistance to the nitric acid, resulting in the higher product yields.

### Relative Performance in the Solution Addition of Sodium Nitrite

FIG. 7 displays the carboxylic acid concentration and total content plotted over the quantity of nitrite used as either a solid or concentrated solution in water. All other reactions conditions were identical. Overall, total content increased when dispensing sodium nitrite as a solution. Further increases were observed when the amount of sodium nitrite was doubled. This is a distinct difference compared to when using solid sodium nitrite, as increasing the sodium nitrite quantity by just 50% resulted in decreases in content and total content, seen in FIG. 3.

Observing the molar quantities of nitric acid to sodium nitrite when added as a solution, 0.77 mols of nitric acid and 0.14 or 0.28 mols of sodium nitrite were calculated in FIG. 7. Nitric acid was still in excess, but as indicated by the lower evolution of reddish-brown gas from the addition of a sodium nitrite solution, less nitrous acid was decomposed to nitrous oxide. Thereby, more nitrosonium ions may be generated.

When adding the sodium nitrite solution over three hours instead of over 1 hour, the carboxylic acid content and total content both decreased, and product yield decreased, where product yield in particular decreased by 33.7%. This may be attributed to essentially exposing the jute to nitric acid for a longer amount of time, and delaying the oxidation process.

### Effect of Reaction Conditions on the Crystallinity Index

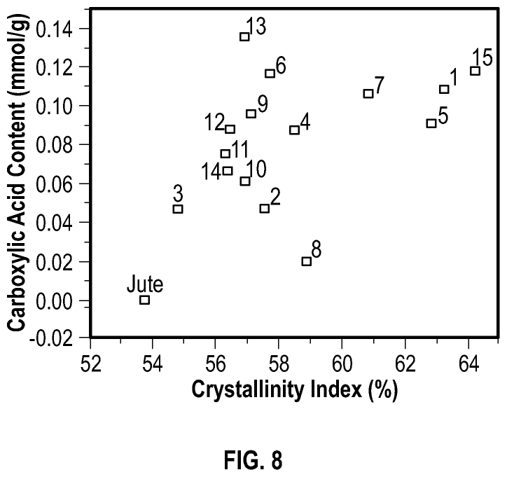

FIG. 8 displays the carboxylic acid content of each sample as a function of its crystallinity index (CI). CI is a measure of crystalline cellulose relative to amorphous cellulose. Cellulose can form crystalline fibers, where the two major packing variations are classified as cellulose I and cellulose II. Cellulose I can also be called native cellulose while cellulose II is sometimes described as either mercerized or regenerated cellulose. Cellulose I is a class containing cellulose I_{α} and cellulose I_{β}, where cellulose I_{α} exists in non-vascular plants such as mosses and algae, while cellulose I_{β} exists in vascular plants. The crystal structure of cellulose I_{β} is perhaps the most studied crystallinity of cellulose, using X-ray diffraction and nuclear magnetic resonance techniques. The unit cell for crystalline cellulose Ip is monoclinic containing two different cellulose chains, and unit cell parameters of a=0.778 nm, b=0.820 nm, c=1.038 nm, and y=96.5°. Reported lattice planes can vary, depending on how the chain axis is defined. In this study, lattice planes of 101, 101̅, 021, 002, and 040, will be used to ascribe crystalline peaks of cellulose I_{β} in wide-angle x-ray diffraction patterns, using the peak deconvolution method.

A summary of peak deconvolution parameters is given below in Table 4.

TABLE 4
Parameters used to deconvolute wide-angle x-ray diffraction
patterns (WAXD) using Gaussian functions. Peak indexes
1-6 correlates with lattice planes 101, 101̅,
amorphous, 021, 002, and 040 respectively.

| | | | | |
|---|---|---|---|---|
| Peak Index | Area | FWHM | Center Gravity | Area (%) |

NOP 1

| | | | | |
|---|---|---|---|---|
| 1 | 23347.4 | 2.6 | 15.2 | 11.1 |
| 2 | 18041.1 | 2.3 | 17.0 | 8.6 |
| 3 | 77009.8 | 10.0 | 22.0 | 36.8 |
| 4 | 4644.8 | 1.8 | 21.2 | 2.2 |
| 5 | 78744.5 | 2.2 | 23.1 | 37.6 |
| 6 | 7689.6 | 2.6 | 35.2 | 3.7 |

NOP 2

| | | | | |
|---|---|---|---|---|
| 1 | 28950.2 | 2.6 | 15.2 | 13.2 |
| 2 | 10676.0 | 1.8 | 16.9 | 4.9 |
| 3 | 93085.2 | 11.6 | 20.7 | 42.4 |
| 4 | 4729.2 | 1.8 | 20.9 | 2.2 |
| 5 | 75829.9 | 2.2 | 22.9 | 34.6 |
| 6 | 6108.3 | 2.6 | 35.0 | 2.8 |

NOP 3

| | | | | |
|---|---|---|---|---|
| 1 | 29007.7 | 2.6 | 15.3 | 12.8 |
| 2 | 10096.9 | 1.8 | 16.9 | 4.5 |
| 3 | 102314.8 | 12.4 | 20.0 | 45.2 |
| 4 | 4724.2 | 1.8 | 20.9 | 2.1 |
| 5 | 76502.6 | 2.2 | 22.8 | 33.8 |
| 6 | 3932.9 | 2.6 | 34.9 | 1.7 |

NOP 4

| | | | | |
|---|---|---|---|---|
| 1 | 26218.6 | 2.6 | 15.2 | 12.3 |
| 2 | 12206.8 | 2.0 | 17.0 | 5.8 |
| 3 | 88326.9 | 11.1 | 21.1 | 41.5 |
| 4 | 4402.2 | 1.8 | 21.0 | 2.1 |
| 5 | 75538.6 | 2.2 | 23.0 | 35.5 |
| 6 | 6153.9 | 2.6 | 35.1 | 2.9 |

NOP 5

| | | | | |
|---|---|---|---|---|
| 1 | 22116.2 | 2.4 | 15.4 | 11.5 |
| 2 | 13102.8 | 2.0 | 17.2 | 6.8 |
| 3 | 71392.5 | 10.3 | 22.4 | 37.2 |
| 4 | 4756.7 | 1.6 | 21.3 | 2.5 |
| 5 | 71630.9 | 2.0 | 23.2 | 37.3 |
| 6 | 9063.6 | 2.4 | 35.2 | 4.7 |

NOP 6

| | | | | |
|---|---|---|---|---|
| 1 | 23469.3 | 2.6 | 15.2 | 12.6 |
| 2 | 9744.2 | 1.9 | 16.9 | 5.2 |
| 3 | 78932.7 | 11.4 | 21.0 | 42.3 |
| 4 | 4003.3 | 1.8 | 21.0 | 2.1 |
| 5 | 65567.7 | 2.2 | 22.9 | 35.1 |
| 6 | 5048.1 | 2.6 | 35.0 | 2.7 |

NOP 7

| | | | | |
|---|---|---|---|---|
| 1 | 12216.4 | 2.2 | 15.5 | 8.2 |
| 2 | 9906.8 | 2.0 | 17.2 | 6.6 |
| 3 | 58597.0 | 10.2 | 22.3 | 39.2 |
| 4 | 3567.5 | 1.8 | 21.3 | 2.4 |
| 5 | 55878.7 | 2.2 | 23.4 | 37.3 |
| 6 | 9442.7 | 2.6 | 35.5 | 6.3 |

NOP 8

| | | | | |
|---|---|---|---|---|
| 1 | 31271.0 | 2.6 | 15.3 | 13.2 |
| 2 | 13245.4 | 1.9 | 17.0 | 5.6 |
| 3 | 97284.9 | 11.0 | 21.0 | 41.1 |
| 4 | 5780.2 | 1.8 | 21.0 | 2.4 |
| 5 | 81389.1 | 2.2 | 22.9 | 34.4 |
| 6 | 7735.1 | 2.6 | 35.1 | 3.3 |

NOP 9

| | | | | |
|---|---|---|---|---|
| 1 | 26436.6 | 2.6 | 15.2 | 12.4 |
| 2 | 12680.3 | 2.0 | 16.9 | 6.0 |
| 3 | 91225.8 | 11.6 | 20.8 | 42.8 |
| 4 | 4795.5 | 1.8 | 21.0 | 2.3 |
| 5 | 72686.9 | 2.2 | 22.9 | 34.1\ |
| 6 | 5091.9 | 2.6 | 35.0 | 2.4 |

NOP 10

| | | | | |
|---|---|---|---|---|
| 1 | 28320.8 | 2.6 | 15.1 | 13.6 |
| 2 | 10104.0 | 1.8 | 16.8 | 4.9 |
| 3 | 89516.7 | 12.3 | 19.9 | 43.1 |
| 4 | 4410.1 | 1.8 | 20.8 | 2.1 |
| 5 | 72588.7 | 2.2 | 22.7 | 34.9 |
| 6 | 2961.8 | 2.4 | 34.8 | 1.4 |

NOP 11

| | | | | |
|---|---|---|---|---|
| 1 | 31822.0 | 2.6 | 15.2 | 13.4 |
| 2 | 11184.0 | 1.8 | 16.9 | 4.7 |
| 3 | 103840.8 | 12.0 | 19.9 | 43.7 |
| 4 | 5529.9 | 1.8 | 20.9 | 2.3 |
| 5 | 80667.6 | 2.2 | 22.8 | 34.0 |
| 6 | 4630.0 | 2.6 | 34.9 | 1.9 |

NOP 12

| | | | | |
|---|---|---|---|---|
| 1 | 28628.6 | 2.6 | 15.2 | 13.3 |
| 2 | 10880.7 | 1.8 | 16.9 | 5.1 |
| 3 | 93555.2 | 11.5 | 20.4 | 43.5 |
| 4 | 4265.5 | 1.8 | 20.9 | 2.0 |
| 5 | 72879.7 | 2.2\ | 22.8 | 33.9 |
| 6 | 4756.3 | 2.6 | 34.9 | 2.2 |

NOP 13

| | | | | |
|---|---|---|---|---|
| 1 | 27211.5 | 2.6 | 15.1 | 14.3 |
| 2 | 9693.3 | 1.8 | 16.8 | 5.1 |
| 3 | 82038.3 | 13.3 | 19.2 | 43.1 |
| 4 | 4950.1 | 1.8 | 20.7 | 2.6 |
| 5 | 65274.4 | 2.2 | 22.7 | 34.3 |
| 6 | 1293.7 | 1.8 | 34.6 | 0.7 |

NOP 14

| | | | | |
|---|---|---|---|---|
| 1 | 25160.6 | 2.7 | 15.3 | 12.3 |
| 2 | 13054.4 | 2.2 | 17.0 | 6.4 |
| 3 | 89029.7 | 10.8 | 21.0 | 43.6 |
| 4 | 5341.1 | 1.9 | 21.1 | 2.6 |
| 5 | 65619.8 | 2.3 | 23.0 | 32.1 |
| 6 | 5929.3 | 2.7 | 35.1 | 2.9 |

NOP 15

| | | | | |
|---|---|---|---|---|
| 1 | 21336.3 | 2.6 | 15.1 | 10.2 |
| 2 | 21573.5 | 2.5 | 16.9 | 10.3 |
| 3 | 74807.8 | 9.8 | 22.2 | 35.8 |
| 4 | 4864.2 | 1.8 | 21.1 | 2.3 |
| 5 | 78813.4 | 2.2 | 23.1 | 37.7 |
| 6 | 7676.1 | 2.6 | 35.2 | 3.7 |

Jute

| | | | | |
|---|---|---|---|---|
| 1 | 4313.1 | 3.0 | 13.3 | 4.3 |
| 2 | 13371.7 | 3.0 | 15.9 | 13.2 |
| 3 | 46812.4 | 13.2 | 22.0 | 46.2 |
| 4 | 3958.2 | 3.0 | 19.7 | 3.9 |
| 5 | 28842.5 | 2.7 | 22.6 | 28.5 |
| 6 | 3981.1 | 3.0 | 35.4 | 3.9 |

Patterns were baselined using a straight line of constant value equal to that of lowest value in the range of 5-45° 2⊖. Six gaussian curves were placed on each diffraction pattern, one for each lattice plane and one for amorphous cellulose. Peak centers for 101, 101̅, amorphous, 021, 002, and 040 were constrained to 14-16, 16-18, 19.5-22.5, 19.5-21.5, 22.5-23.5, and 34.5-35.5° 2⊖, respectively. Constraints for peak centers were disabled after several fitting iterations, so that constraints did not heavily influence peak positions. After several fitting iterations, the full width at half maximum (FWHM) develops for the strongest crystalline peak, 002.

The FWHM for 002, shown as peak index 5 in Table 4, was just under 2.2 for most samples. The unique FWHM for each fitting was used to set the constraints for all other crystalline peaks in the diffraction pattern, specifically=0.4. The 002 peak being the strongest crystalline peak in each sample is used as a reference in this regard on how to guide the FWHM for crystalline peaks. The FWHM for the amorphous cellulose, shown as peak index 3 in Table 4, was not constrained. The typical FWHM for amorphous cellulose is greater than 9, and in some instances the FWHM would have to be initially set to a higher value, such as 9, before fittings would converge at this higher range automatically. In general, the peak area was not constrained, except for constraining the area to positive values only. Fittings were iterated until converged, with a tolerance of 1.0×10⁻⁶.

FIG. 8 displays the carboxylic acid content as a function of crystallinity index. There is no clear trend between the two parameters, as the crystallinity reflects the supramolecular structure of cellulose, and not the surface structure. This is demonstrated by NOP 8, which used no sodium nitrite, so nitric acid alone could induce relatively higher crystallinity indexes without significantly increasing the carboxylic acid content. As also seen in FIG. 8, NOP 13 had the highest carboxylic acid content of the study, but a crystallinity index below average. NOP 13 used a pulping temperature of 60° C., so it is hypothesized that at this temperature lignin may be in a rubbery and more accessible state for nitric acid. If lignin was more accessible, nitric acid may not degrade amorphous cellulose, and reflect only a small increase in crystallinity.

NOP 15, having a crystallinity index of 65.31%, had the highest crystallinity index in the study. This is surprising, considering it is higher than reactions using bleached jute. While the sodium chlorite pulping process can remove lignin, this is in contrast to nitric acid pulping, which can dissolve lignin and cellulose. This is further illustrated observing the product yields for NOP 1 (jute) and NOP 5 (bleached jute), of 30.12 and 72.1% respectively.

### Comparison of Crystallinity Index Using WAXD and FTIR

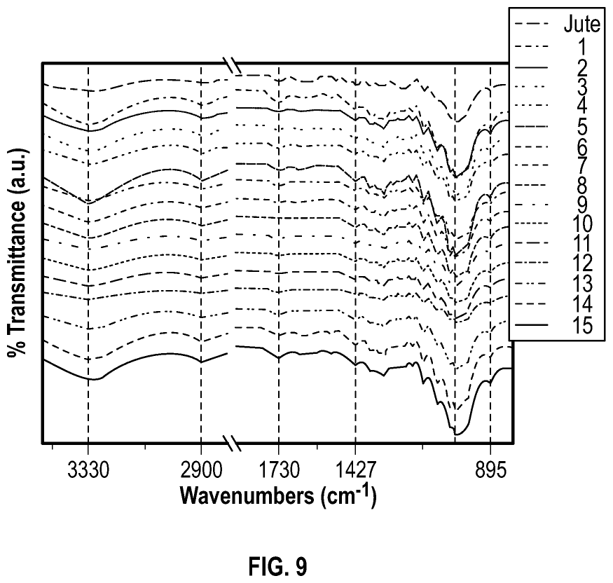

The Fourier transform infrared spectra are shown in FIG. 9. Major peaks include O—H stretching at 3330 cm⁻¹ from hydroxyl groups, C—H stretching at 2900 cm⁻¹, C═O stretching at 1730 cm⁻¹ from carboxylic acid groups, and C—O stretching at 10³⁵ cm⁻¹ from glycosidic linkages.

There are several variations for determining the crystallinity index of cellulose using FTIR. The variations compare the relative intensities or areas of two peaks. In this study, the lateral order index (LOI) variation was used, which was calculated by dividing the intensity at 1427 cm⁻¹ by 895 cm⁻¹. The peak at 1427 cm-1-1429 cm⁻¹ is contributed to CH₂ scissoring, which only occurred on the C6 carbon of cellulose. The peak at 895 cm⁻¹ is associated with a vibrational mode at C1, and closely associated with β-linked glucose polymers. The method was developed when studies showed the relative band intensity at 1427 cm⁻¹ decreased compared to 895 cm 1 in ball-milled cellulose, which was more amorphous. It is postulated that in cellulose I, the O6 oxygen, which is the primary alcohol, hydrogen bonded with 02 oxygens via intramolecular hydrogen bonding and with O3 oxygens via intermolecular hydrogen bonding. This regular hydrogen bonding is not expected in amorphous cellulose, which is not regularly ordered with other cellulose chains, and has more rotational freedom around its glycosidic linkage. The chemical compositions of crystalline and amorphous cellulose is very similar, but it is typically observed in FTIR spectroscopy that bonds of the same strength and orientation will be displayed as sharper peaks. In amorphous cellulose, hydrogen bonding is more disordered, resulting in broader peaks.

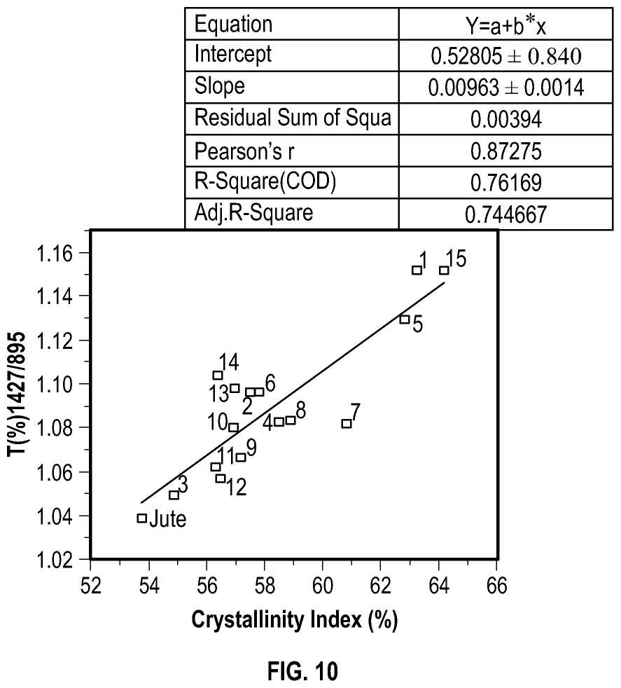

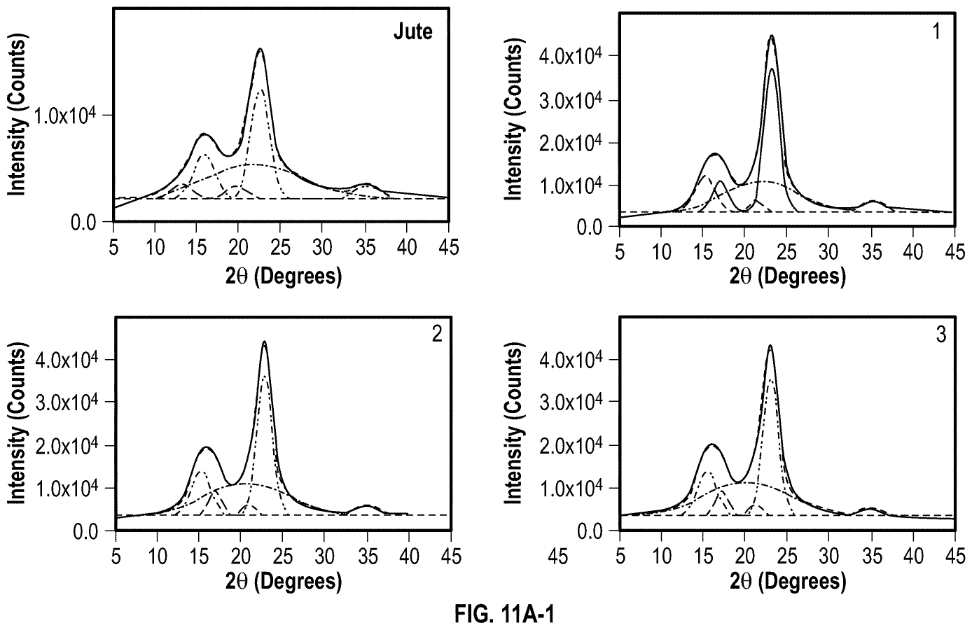

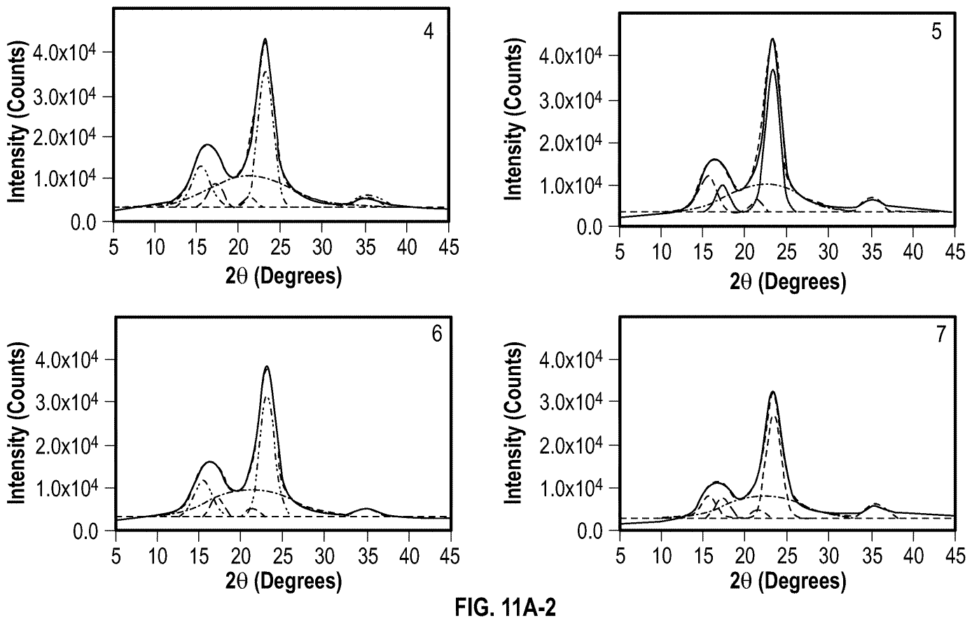

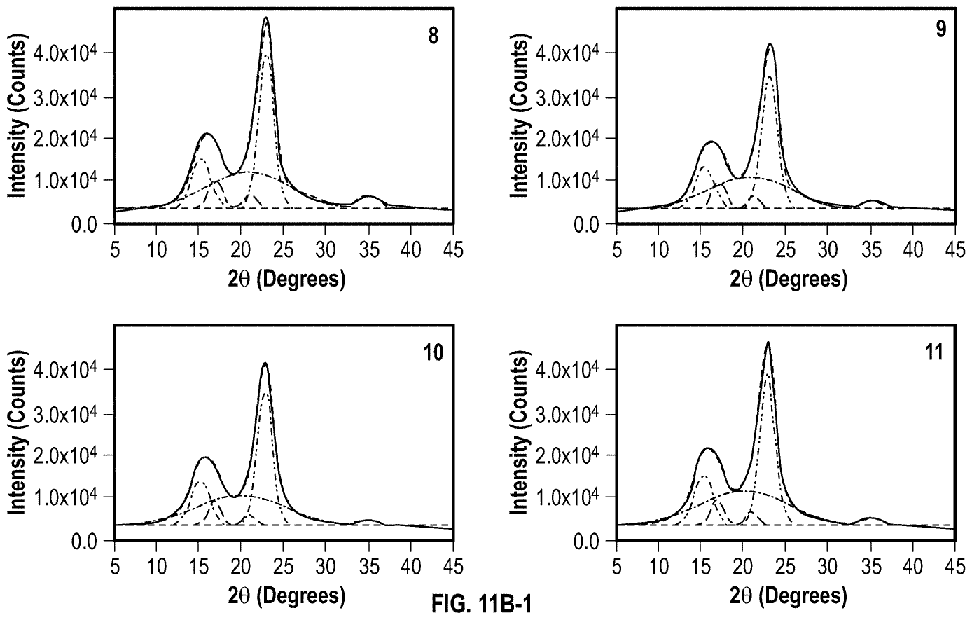

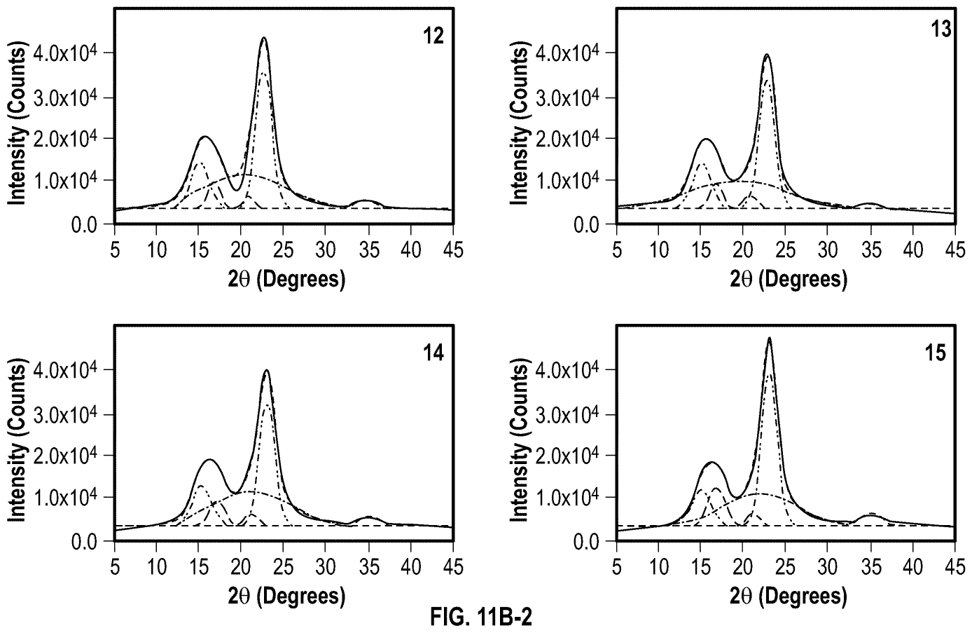

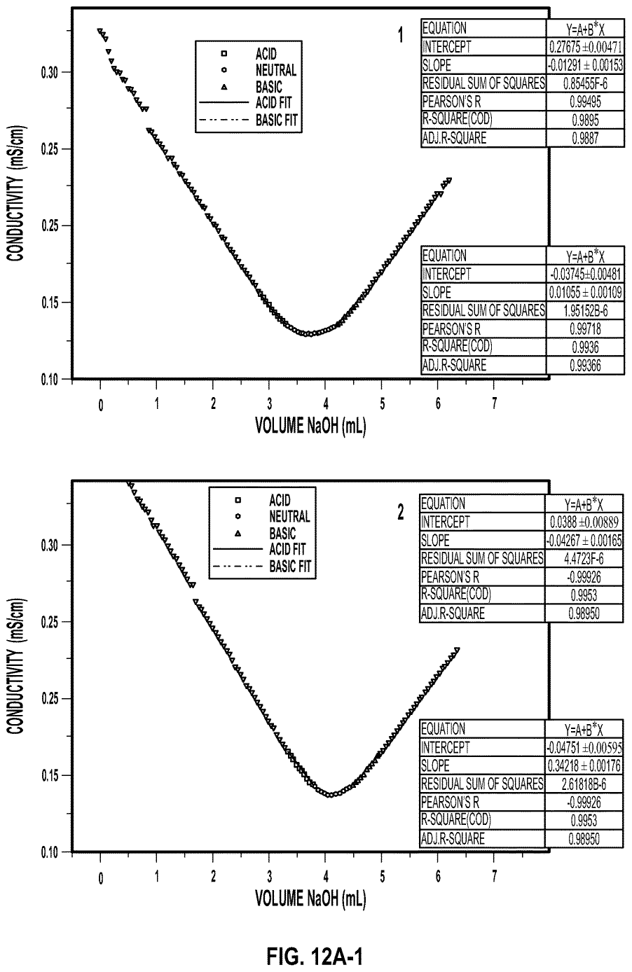

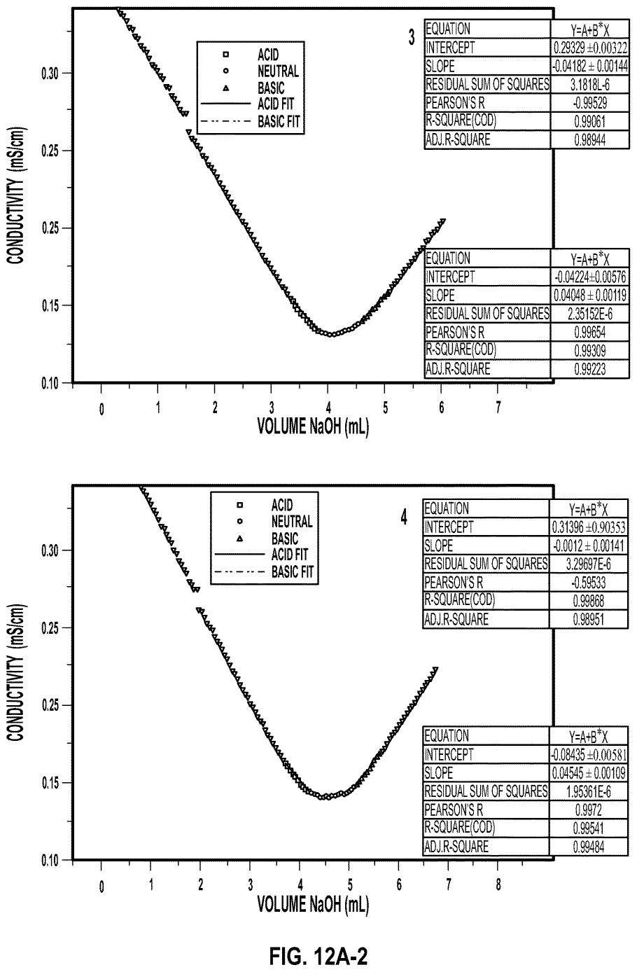

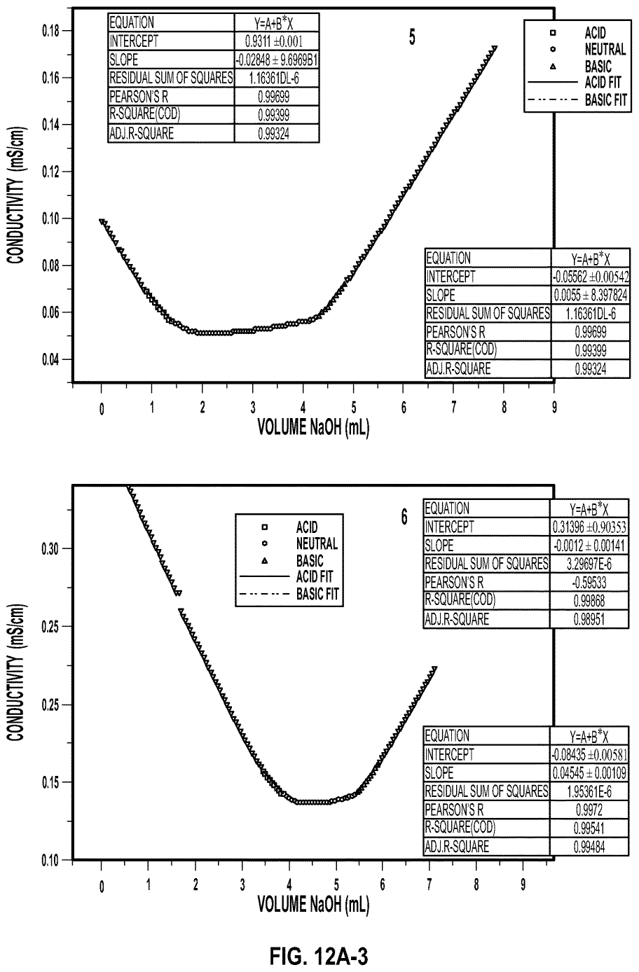

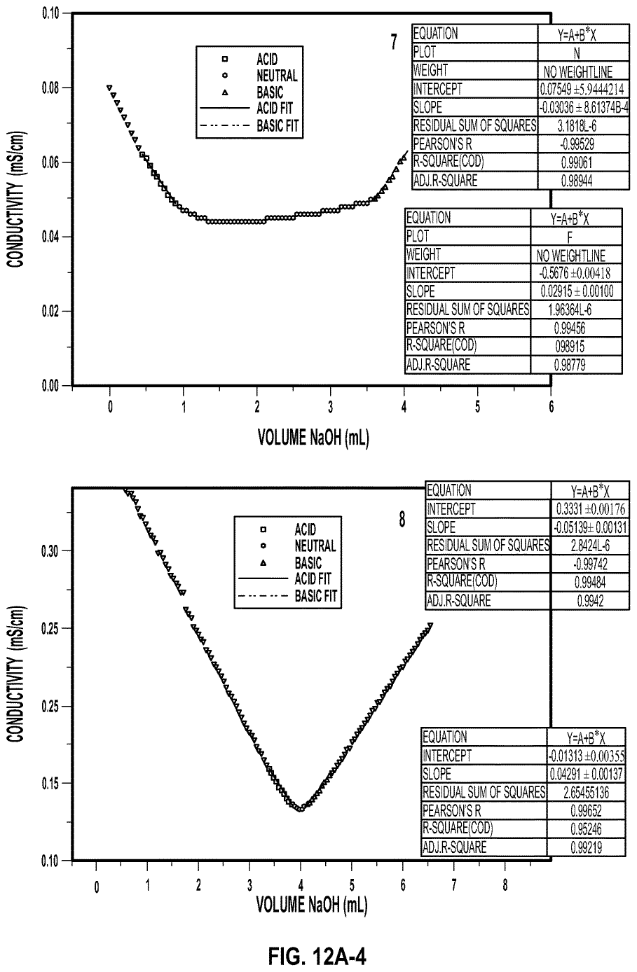

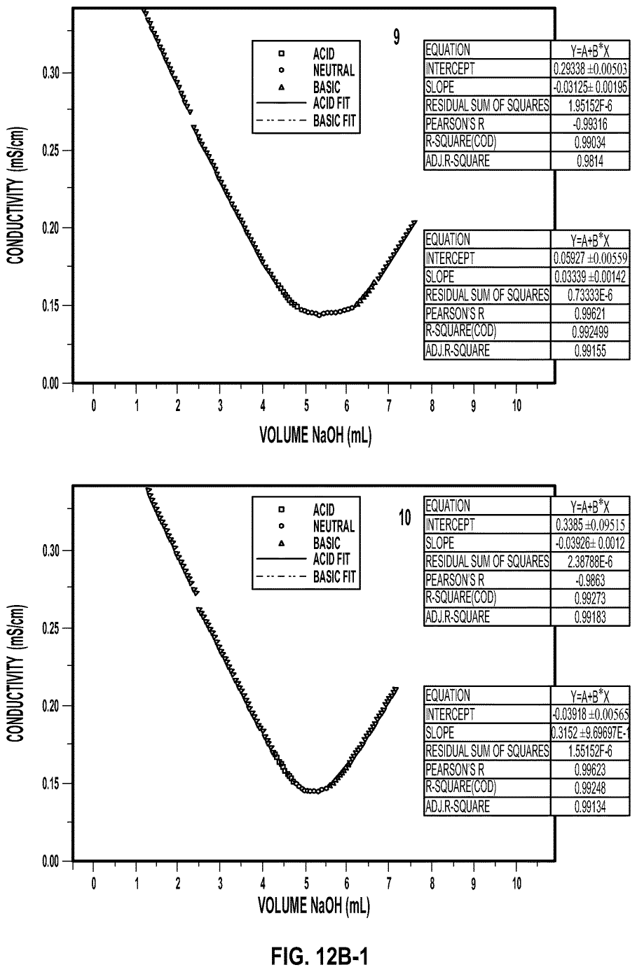

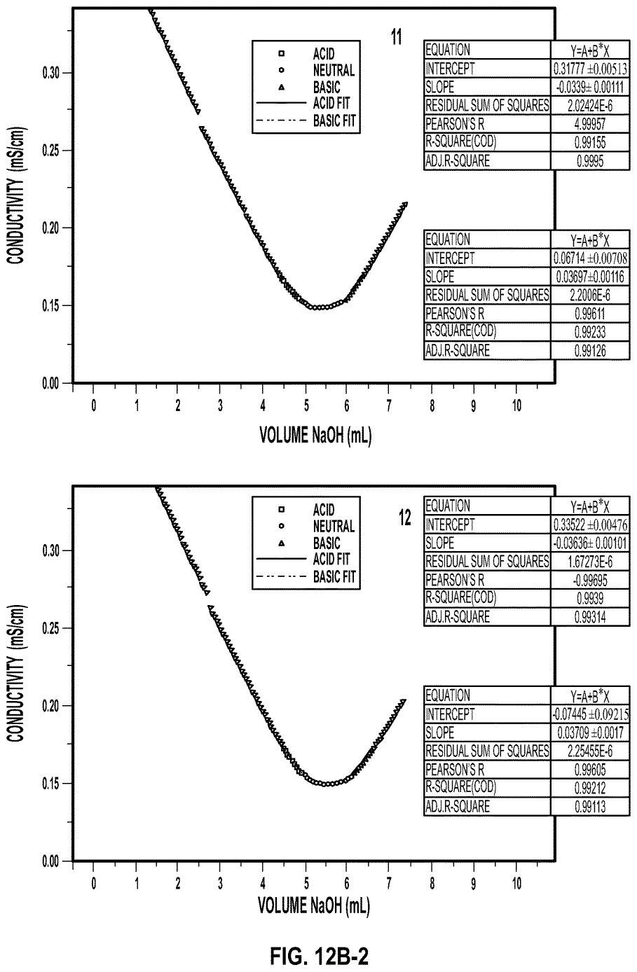

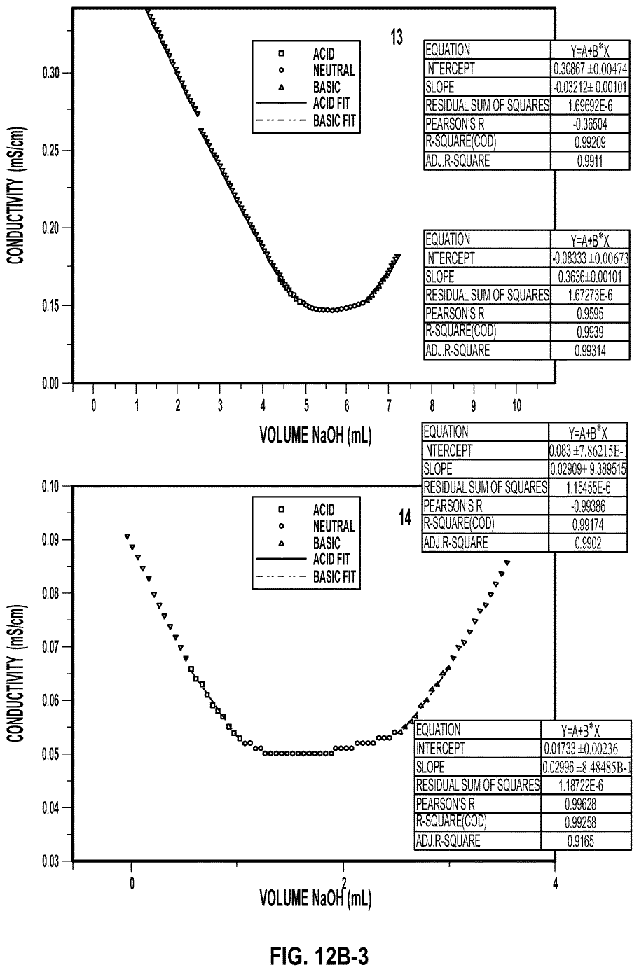

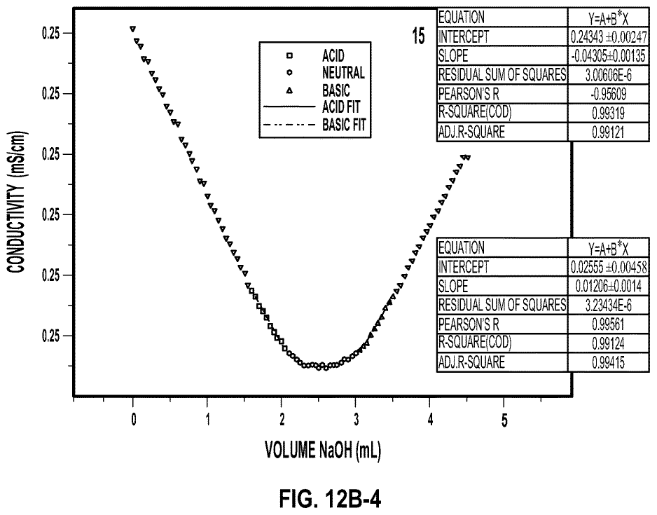

FIG. 10 plots the % transmittance measured at 1427 cm⁻¹ divided by the % transmittance measured at 895 cm⁻¹ as a function of the crystallinity index (%). Fitting a linear line through the data points, a coefficient of determination (COD) R-squared value of 0.76 was calculated.

Overall, the above examples demonstrated a method for the production of carboxylated cellulose fibers using a lower concentration of nitric acid (30%) that was more scalable and safer than the original NOP using a higher concentration of nitric acid (>60%). Although the resulting carboxylic acid content was significantly lower than what is achieved with the conventional NOP process, the above examples demonstrate the effectiveness of using lower concentration nitric acid, less reaction time, and achieves higher pulp yield. Furthermore, the examples demonstrate how nitric acid can be used more effectively by increasing pulping temperature to 60° C., possibly by increasing exposure to lignin. The oxidation process was shown to perform better than then a pulping and oxidation approach, given the advantage of increased reaction time and reducing the degradation of jute. Also, using room temperature pulping temperature and then increasing the oxidation temperature to the default of 50° C. achieved better results. Overall, pulping with nitric acid at temperatures of 50° C. demonstrated significant degradation of the jute. Alternatively, skipping the pulping phase and oxidizing the cellulose via a solution of sodium nitrite or pulping at higher temperatures yielded the best results.

### Example 3

Jute fibers were cut down to 5 cm and were oxidized. Briefly, 1.0 gram of jute fibers was soaked in 14 ml of 65% nitric acid, followed by the addition of sodium nitrite. The amount of sodium nitrite varied depending on the target carboxylate content in NOCNF. Specifically, 0.96, 0.48, and 0 grams of sodium nitrite were used to produce NOCNF with carboxylate contents of 1.1, 0.8, and 0.2 mmol per gram of NOCNF (labeled NOCNF 1.1, NOCNF 0.8, NOCNF 0.2), respectively.

Upon addition of sodium nitrite, the round bottom flask was immediately sealed to prevent the loss of fumes created from the reaction. The round bottom is held at 50° C. for 12 hours, then quenched with 250 ml of deionized water. The supernatant was then decanted 2-3 times before being washed by centrifugation at 5000 relative centrifugal force (rcf) for 10 minutes to a pH equal to or greater than 2.5. The fibers were then dialyzed using deionized water until there was no further change in conductivity within 24 hours.

The obtained fibers at this point have carboxylic acid functional groups. Fiber slurries were treated with sodium bicarbonate until the pH of the suspension reached 7.5. The sodium bicarbonate treatment yielded carboxylate functional groups with sodium counter ions. Fibers were then dialyzed using deionized water until there was no longer a change in conductivity within 24 hours. The slurry was passed through a homogenizer at 250 bar for 1 pass to fibrillate the fibers into NOCNF. Samples were left on dialysis until use.

### Example 4

Preparation of TEMPO-oxidized CNF. As a comparison to other oxidized cellulose nanofibers, TEMPO-mediated oxidized cellulose nanofibers (TEMPO-CNF) were tested for ammonium adsorption. Briefly, 10 grams of ground bleached jute was suspended in water with 0.16 grams 2,2,6,6-tetramethylpiperidine-1-oxyl (TEMPO) and 1.0 grams of sodium bromide. The reaction was initiated with sodium hypochlorite, stirred, and maintained at pH 10 using a dilute sodium hydroxide solution. Once sodium hydroxide was no longer consumed, the sample was thoroughly washed using dialysis tubing and defibrillated using a high-pressure homogenizer. Samples were left on dialysis until use. Carboxylate contents of 1.20, 1.14, and 0.86 mmols per gram of TEMPO-CNF (labeled TEMPO-CNF 1.2, TEMPO-CNF 1.14, TEMPO-CNF 0.86) were achieved using sodium hypochlorite concentrations of 14, 11, and 8 mmol of sodium hypochlorite per gram of cellulose, respectively.

### Example 5

Remediation studies. The concentration of active ammonium in solution was determined using an ammonium ion-selective electrode (ISE) by Vernier. When testing adsorption capacity, 3 ml of CNF and 3 ml of ammonium solution made from ammonium chloride of various concentrations were added to a test tube. In this study, ppm of ammonium is an expression of the ammonium itself, and not of ammonium chloride. Because other studies may use other ammonium-based salts, it is easier to compare results when considering only ammonium. However, it is important to disclose what salt was used, in case of any influencing factors from the counter ion. After stirring the sample for 10 seconds, it was then left to incubate at room temperature for 24 hours. Samples were then centrifuged at 10,000 rcf for 10 minutes. The supernatants were separated and measured for ammonium using an ammonium ISE. When testing adsorption capacity as a function of pH, samples were adjusted with aqueous solutions of dilute sodium hydroxide or dilute hydrochloric acid and incubated for 24 hours before centrifugation. In the pH testing, all supernatants were adjusted to a pH value of 5 and diluted to the same volume. All samples were tested against a control of the same pH, volume, and/or concentration.

The reusability of NOCNF was tested using a sodium hydroxide regeneration method. For the first cycle, a fixed volume of 25 ppm ammonium solution made from ammonium chloride was stirred into a NOCNF suspension, which was centrifuged to remove excess water. Following a waiting period of five minutes, the supernatant was recovered using centrifugation and measured for ammonium uptake. The solid sample that remained was then washed with an equal volume of 0.1 M sodium hydroxide. After centrifuging the sodium hydroxide away, the solid was rinsed with an equal volume of deionized water. After centrifuging the rinse water away, another equal volume of 25 ppm ammonium solution is added to the solid to start another cycle.

A column filtration experiment was conducted by using a fritless column with an adjustable stopcock. Cotton was placed at the bottom of the column to prevent loss of sample. 1 gram of freeze-dried NOCNF 1.1 was placed into the column. 20 ppm ammonium solution was poured into the column and collected at an average rate of 0.1 ml/min. Effluent was collected at specified time intervals. Concentrations of ammonium in effluent samples was determined.

### Example 6

Plant growth and nitrogen composition study. The nitrogen composition of nitrogen containing treatments was quantified for determining how much treatment to add to the soils. Treatments were added to approximately 20 grams of soil, then blended in a blender thoroughly. The blended soil was then placed in a large sealable plastic bag with 430 grams of plain soil. The amount of treatment added was calculated so the elemental nitrogen composition was 100 mg of nitrogen per kilogram of soil. The 450 grams total of soil was shaken for several minutes, then left for 24 hours.

The next day, the bag of soil was shaken again for several minutes to ensure soils were homogenous. 50 grams of soil was placed into each of the 9 pots per soil type. Soybean seeds, glycine max, were soaked for 24 hours in water, submerging the seeds halfway. Two seeds were placed into each pot. After 2 days, the smaller of the two sprouted seeds were removed, so that only one plant remained in each pot. This concluded the germination process.

Plants were watered by hand, to avoid excessive leaching. Using the control sample, the minimum amount of water before water began eluting from the bottom of the pot was determined. This amount of water would be administered to all other plants. Plants were watered every other day. Trays of plants were shifted every other day, in an attempt to equalize other control variables, such as relative heating and sunlight. Plants were kept in a greenhouse, with access to sunlight.

After the germination process, three plants from each soil treatment are harvested every week for three weeks. The harvesting process separates the roots, stems, and leaves of each plant. They are dried at 60° C. for 3 days. Samples are then weighed to determine mass, then ground into a powder for elemental nitrogen composition analysis.

The control sample consisted of untreated soil. The urea treatment consisted of a concentration of urea. The ammonium-loaded NOCNF treatment was prepared by mixing equal parts 0.1 wt. % NOCNF 0.8 with 100 ppm ammonium solution made from ammonium chloride. The suspension was allowed to equilibrate over 24 hours. The suspension was centrifuged at 20,000 rcf for 10 minutes, in an effort to remove as much salt solution from the suspension. It should be noted that not all of the salt solution can be removed. Furthermore, the NOCNF was not homogenized. The suspension was thusly a mixture of microfibers with a minor contribution of nanofibers. This was in an attempt to reduce the swelling of the material. NOCNF absorbed quite a bit of salt solution, which is not reflective of the ammonium adsorption.

Washing the ammonium-loaded NOCNF was avoided, due to a noticeable decrease in adsorbed ammonium. Nonetheless, all nitrogen containing treatments were measured for nitrogen content. The potassium bicarbonate treatment consisted of a concentration of potassium bicarbonate. The potassium bicarbonate neutralized NOP effluent treatment was prepared as follows. 200 ml of NOP effluent from a reaction similar to the reaction used to produce NOCNF 0.8 was placed in a beaker under stirring. The pH of the solution was approximately 0.5. Potassium bicarbonate solution was added to the solution until the pH value reached 6-7. The neutralized solution was then dried in an oven at 60° C. for 3 days. The dried solid was crushed in a mortar in pestle to yield a homogenous powder.

### Example 7

Sample characterization—ammonium ion selective electrode. Ammonium concentration was determined using an ammonium ion selective electrode (ISE). The IntelliCAL ISENH4181 probe by Hach was equipped with a non-refillable Dritek gel reference and double junction encased in an Epoxy body. The chosen ISE employed an Ag/AgCl reference electrode and solid-state PVC membrane sensor.

### Example 8

Conductive Titration Method. 40 grams of NOCNF suspension was diluted with 160 grams of water to 0.2 wt. % and stirred at 300 rotations per minute (rpm). The dilution allows for the suspension to be stirred easily and avoids excessive gelation when adding salt solutions.

The pH of the suspension was adjusted to pH 2.5 using dilute hydrochloric acid. The suspension was then titrated with 0.05 M sodium hydroxide in 1 ml increments until reaching a pH of 9 (we note that more dilute solutions of sodium hydroxide may be used). Regardless, it is important to measure the pH of the titrant to calculate the concentration more accurately. The conductivity of the sample was measured and plotted over volume of titrant.

The resulting graph should have three linear curves. From volume 0 to V₁, adding titrant should decrease the conductivity up until a certain volume. This certain volume was designated as V₁. This is a result of neutralizing the free acid in the suspension which is present due to adding an excess amount of acid relative to the carboxylate content, and where acid is much more conductive than sodium or chloride. Adding additional titrant would not change the conductivity of the suspension, since doing so would neutralize protons bound to the carboxylate groups. This was true to a certain volume, and that volume is designated as V₂. After this volume, additional titrant introduces free hydroxide, which will increase the conductivity. The carboxylate concentration can be calculated using equation 1 above.

### Example 9

Zeta potential. Colloidal particles are electrically charged particles that are typically in a stable suspension in some dispersing media. Colloids can range from aerosols, foams, emulsions, sols, gels, and solids. NOCNF behaves as a solution when diluted, where the oxidized cellulose is a solid particle dispersed in liquid water (functioning as the dispersion medium). The colloidal particles are electrically neutral, because each particle is balanced by another respective particle of the opposite sign. The distribution of these ions is how the electrical double layer is formed. The electric double layer is composed of three main parts. The dispersed particle in a colloidal suspension has some surface charge. This surface charge is balanced by counterions of the opposite sign, and are attracted via Coulomb forces, also called electrostatic forces. This second component is called the Stern layer, and the boundary of this layer is called the Stern plane. The diffuse layer is the third component, consisting of the dispersion media and more counterions, which are loosely attached to the particle. These two layers are then defined as the electric double layer. The boundary of the diffuse layer is defined as the slipping plane. The electric potential in the electric double layer is greatest at the Stern layer, and approaches zero at the slipping plane. The electric potential at the slipping plane is defined as the zeta potential.

The average zeta potential of the samples was taken on a ZetaProbe Analyzer by Colloidal Dynamics. Samples were measured using a dielectric constant of 5.0 and density ratio of 1.5 g/ml. Samples were stirred at 300 rpm and titrated with an auto-burette. Water was used to suspend all samples. The instrument used a niobium electrokinetic sonic amplitude (ESA) electrode and KSiW calibration suspension. Samples were treated with either hydrochloric acid or sodium hydroxide using an auto-burette to achieve the desired pH before analysis.

### Example 10

Fourier transform infrared spectroscopy (FTIR) was recorded on a Nicolet iS10 FT-IR Spectrometer by Thermo Scientific using attenuated total reflectance (ATR) mode. 16 scans were averaged at a resolution of 4. Instruments used a DTGS KBr detector, KBr beam splitter, IR source, Smart iTR accessory, and diamond window. Samples were generally measured from 400-4000 cm⁻¹.

### Example 11

Thermogravimetric analysis (TGA) was taken on a TA Q50. Sample was heated from 25° C. to 850° C. at 10° C. per minute, under a nitrogen atmosphere. Sample mass was monitored over temperature. Sample was loaded and measured on a platinum pan. The derivate weight, shown as %/min, plotted over temperature is known as derivative thermogravimetry (DTG), and more clearly shows small changes in weight.

### Example 12

A MiniFlex from Rigaku was used to measure and record wide-angle X-ray diffraction (WAXD) patterns. The samples were measured from 5 degrees to 100 degrees, measured in steps of 0.02 degrees, and a speed of 5 degrees per minute. The scan axis was set to theta/2-theta, in continuous mode, and intensity measured in counts per second (CPS). The voltage and current were set to 40 kV and 15 mA respectively, using Cu Kα radiation. An incident side and receiving side soller slit of 5.0 degrees along with an incident-beam divergence-limiting slit of 1.250 degrees were used.

### Example 13

Atomic force microscopy (AFM) measurements were performed using a Bruker Dimension ICON atomic force microscope by Bruker. The instrument was equipped with a Bruker OTESPA tip with a tip radius of 10 nm. 10 μL of a 0.005 wt. % suspension was deposited on the surface of a silica plate and air-dried. The sample was measured in tapping mode.

### Example 14

Transmission electron microscopy (TEM) was conducted on a JEOL JEM 1400 at an accelerating voltage of 120 kV. The samples were prepared on 300 mesh copper grids (Ted Pella Inc) by casting 10 μL of a 0.01 wt. % sample onto a grid. After removing the excess fluid, the sample was stained with 10 μL of 2 wt. % aqueous uranyl acetate solution. Excess solution is removed, and grid is left to air dry.

### Example 15

Scanning electron microscopy (SEM) was taken on a ZEISS Crossbeam 340 at an electron high tension of 3 kV and accelerating voltage of 30 kV. Samples are prepared by casting a 0.1 wt. % suspension of NOCNF on a silicon wafer, then coated by gold sputtering.

### Example 16

Elemental Nitrogen Analysis. A 628 Series elemental analysis by combustion instrument made by LECO was used to determine the elemental nitrogen composition of samples. In this study, 0.2 grams of dry ground sample was packed into an aluminum pellet. Sample masses were entered into the instrument software, where aluminum pellets are placed into a gravity fed autoloader. Samples were heated to 1050° C. using oxygen gas.

### Results and Discussion

### Structural Characterization

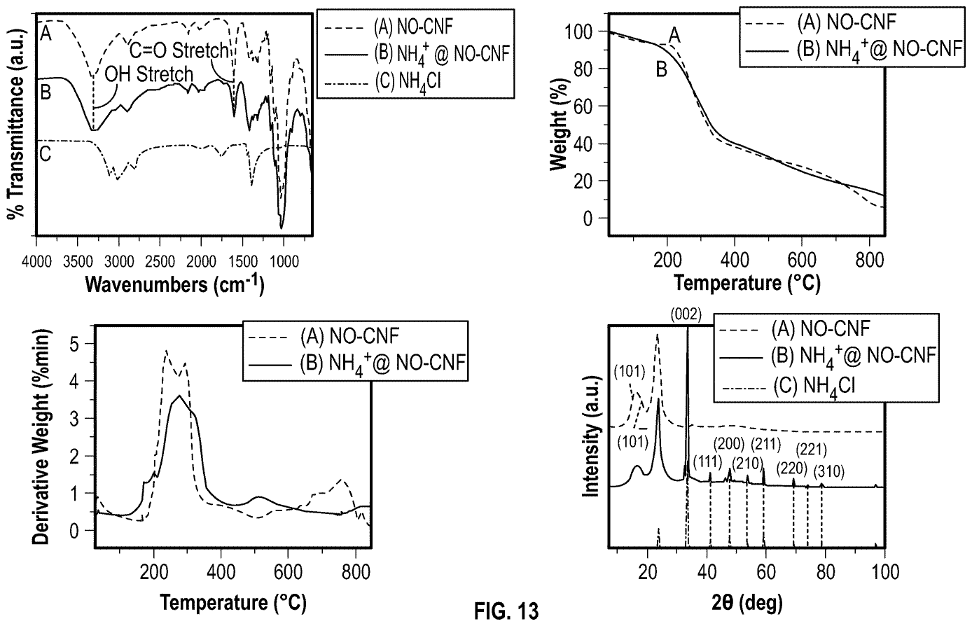

The chemical changes of jute fibers after the nitro-oxidation process and sodium bicarbonate treatment were evaluated by FTIR with results set forth in FIG. 13 (i). FTIR indicated the corresponding major peaks of the cellulose backbone at: 3339 cm⁻¹ from the O—H stretch of the hydroxyl groups, 2894 cm⁻¹ from C—H stretching, and 10³⁵ cm⁻¹ from C—O stretching. NOCNF shows a distinct peak at 1602 cm⁻¹ due to C—O stretching confirming the presence of carboxylate ion groups formed by the Nitro-oxidation process and sodium bicarbonate treatment.

FIG. 13 (ii) and (iii) present the TGA of NOCNF. The data represents the weight as a function of temperature. This data provides information on the thermal stability of the material and the residual mass left upon thermal degradation. The onset degradation temperature for NOCNF started at 165° C. In NOCNF, the first degradation temperature was associated with glucuronic acids of cellulose. The residual weight percent left at 850° C. was around 10%, corresponding to pyrolyzed hemicelluloses and lignin components present in NOCNF.

FIG. 13 (iv) represents the WAXD patterns of NOCNF. A cellulose I structure is indicated by 2θ peak positions at 16°, 18°, and 24° corresponding to the (101), (101̅), and (002) planes, respectively. The cellulose I crystal structure of jute is maintained after modification via the nitro-oxidation process.

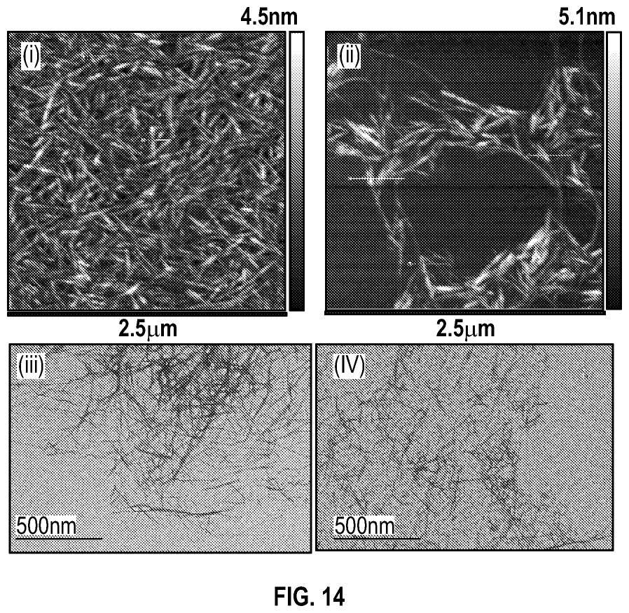

AFM and TEM images in FIG. 14 depict the morphology of the samples. NOCNF appeared fiber-like and no major changes were seen in samples mixed with ammonium chloride. Microscopy images show that despite using concentrated nitric acid, the fiber like structure was maintained, similarly to that of TEMPO-CNF which was oxidized in more mild reaction conditions, pH≈10.

### Characterization of Recovered Ammonium-Loaded NOCNF

The thermal degradation of ammonium-loaded NOCNF was studied with the results presented in FIGS. 13 (ii) and (iii). The onset degradation temperature of ammonium-loaded NOCNF was 115° C., lower than that of NOCNF (165° C.). From DTG, it was observed that this first peak had a maximum derivative weight at 204° C. It is reported that ammonium chloride has a reversible crystallographic transition temperature at 186° C., and causes small changes in mass. Because the NOCNF after ammonium adsorption is expected to contain some crystalline ammonium chloride, this peak was also observed. Ammonium chloride decomposes into ammonia and hydrogen chloride gas at 338° C. This corresponds to the right shoulder of the major DTG peak.

The chemical form of ammonium after adsorption onto NOCNF was indirectly confirmed by X-ray diffraction of the ammonium-loaded NOCNF, as shown in FIG. 13 (iv). The X-ray diffraction pattern of the ammonium-loaded NOCNF had 2θ peak positions at 16°, 18°, and 24°, consistent with the (101), (101̅), and (002) planes of NOCNF. The other peaks of ammonium-loaded NOCNF at 23.7°, 33.7°, 41.13°, 47.7°, 53.6°, 59.1°, 69.3°, 73.7° and, 78.7° with respective planes of (100), (110), (111), (200), (210), (211), (220), (221), and (310) match that of ammonium chloride. There were two unique minor peaks in ammonium-loaded NOCNF at 32.7° and 46.5°, with respective planes of (200) and (220) for sodium chloride. This indicated that the small amount of sodium chloride salt formed from the exchange of the original counter ion of NOCNF for ammonium.

### NOCNF Removal Efficiency for Ammonium

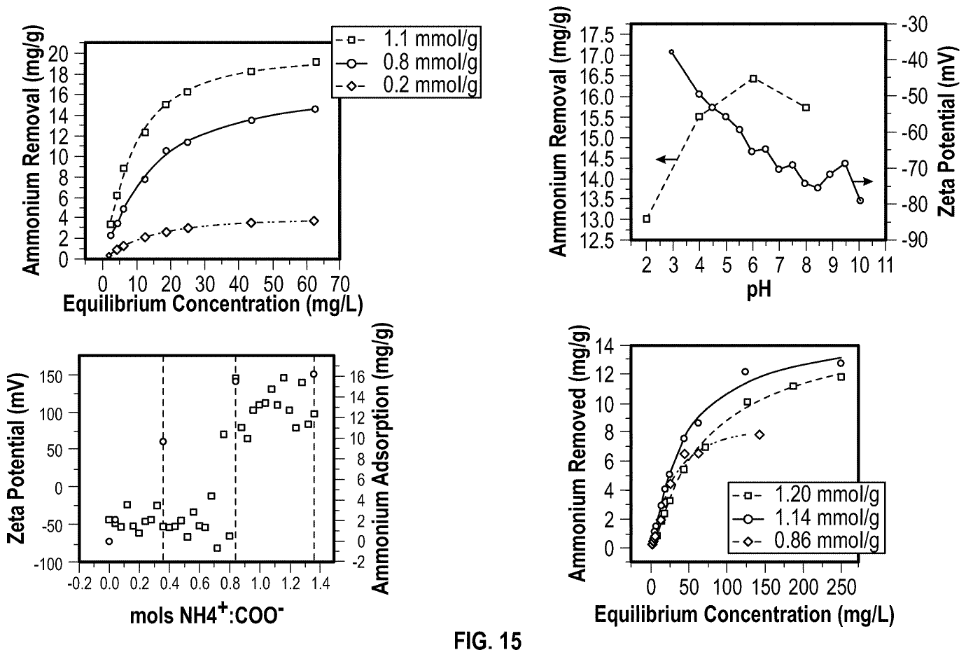

FIG. 15 presents the adsorption capacity of NOCNF as a function of equilibrium ammonium concentration. Three NOCNF samples with different carboxylate contents of 1.1, 0.8, and 0.2 mmol/g were prepared and tested for ammonium adsorption (samples referred to as NOCNF 1.1, NOCNF 0.8, and NOCNF 0.2). Additionally, TEMPO-CNF with varying carboxylate contents of 1.20, 1.14, and 0.86 mmol/g were used for ammonium adsorption as shown in FIG. 15 (samples referred to as TEMPO-CNF 1.2, TEMPO-CNF 1.14, and TEMPO-CNF 0.86). In all cases, a common trend was observed that the adsorption capacity for all CNF samples increased with an increase in ammonium equilibrium concentration up to a limit. The observation is caused by the saturation of adsorptive sites on CNF due to the interaction of an equivalent mass of positively charged ammonium ions. Langmuir and Freundlich isotherm models were used to model the adsorption behavior, with fitting data summarized in Tables 5 and 6. These two models represent the monolayer and multilayer adsorption modes, respectively. It was interesting to note that a greater percentage of ammonium was removed at lower equilibrium concentrations of ammonium, while higher absolute removal occurred at higher equilibrium concentrations. NOCNF 1.1 and NOCNF 0.8 show the percent removals of 46.9-51.9% at 2.5 ppm ammonium, and 11.8-13.7% removal at 62.5 ppm ammonium. The lower carboxylate ion containing NOCNF 0.2 has a 39.4% removal at 2.5 ppm ammonium and a 17.3% removal at 2.5 ppm ammonium.

Based on the Langmuir isotherm, the maximum adsorption capacity (Qₘ) can be calculated, where Qₘ is a theoretical value extrapolated from the fitting curve as follows. The experimental results used for the Langmuir isotherm modeling of all tested CNF samples are shown in Table 5. The Langmuir isotherm model is expressed as follows:

$$Langmuir equation {Q}_{e} = \frac{{Q}_{m} b {C}_{e}}{1 + b {C}_{e}} \qquad ( 2 )$$

where, Qₑ is the equilibrium adsorption capacity, Cₑ is the equilibrium concentration of ammonium, Om is the monolayer maximum adsorption capacity, and b is the Langmuir adsorption constant. Om is determined as the inverse slope calculated from the linear fit when plotting Cₑ/Qₑ against Cₑ.

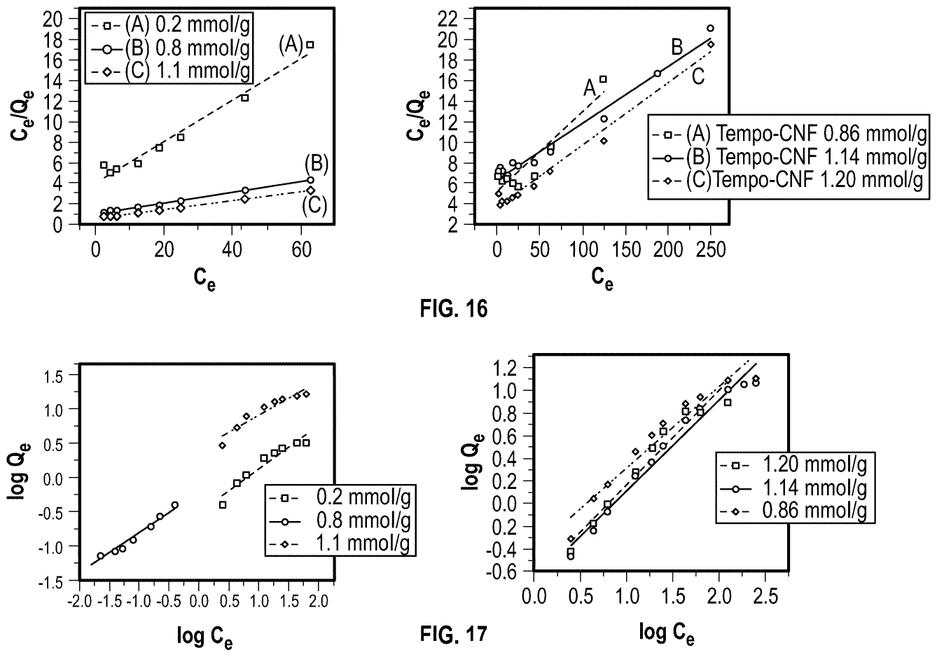

TABLE 5
Langmuir fitting and maximum adsorption by cellulose
nanofibers (CNF) summarized from FIG. 16.

| | | | | Qm |
|---|---|---|---|---|
| CNFs | Intercept | Slope | R2 | (mg/g) |
| NOCNF 1.1 | 0.500 ± 0.041 | 0.044 ± 0.001 | 0.993 | 22.7 |
| NOCNF 0.8 | 0.943 ± 0.044 | 0.052 ± 0.001 | 0.994 | 19.2 |
| NOCNF 0.2 | 3.991 ± 0.392 | 0.201 ± 0.013 | 0.970 | 4.97 |
| TEMPO-CNF 1.2 | 3.666 ± 0.263 | 0.061 ± 0.003 | 0.981 | 16.4 |
| TEMPO-CNF 1.14 | 6.477 ± 0.294 | 0.055 ± 0.003 | 0.970 | 18.2 |
| TEMPO-CNF 0.86 | 5.229 ± 0.558 | 0.078 ± 0.011 | 0.859 | 12.8 |

In contrast, the Freundlich isotherm model can be expressed as follows:

$$log ( Q e ) = log ( {K}_{F} ) + \frac{1}{n} log ( C e ) \qquad ( 3 )$$

where the log Qₑ is plotted against log Cₑ where a linear fit is applied. Kr is taken as the intercept of the linear fit and n is taken as the inverse of the slope of the linear fit.

Using the Langmuir isotherm, a Qₘ of 22.7 mg/g with an R² of 0.992 was calculated for NOCNF 1.1. The Qₘ value for NOCNF 0.8 was 19.2 mg/g with an R² of 0.994, and for NOCNF 0.2 was 4.97 mg/g with an R² of 0.970. The good isotherm R² values for all NOCNF samples demonstrated good conformity with the Langmuir isotherm model. The trend in adsorption capacity using NOCNF provided evidence that the content of carboxylate groups is responsible for the ammonium adsorption, and the ammonium adsorption can be adjusted via the concentration of carboxylate groups.

TEMPO-CNF samples were also tested for ammonium removal, and the results are shown in FIG. 15. A Qₘ value of 16.4 mg/g with an R² of 0.981 was calculated for TEMPO-CNF 1.2. The Om value for TEMPO-CNF 1.14 was 18.2 mg/g with an R² of 0.970, and for TEMPO-CNF 0.2 was 12.8 mg/g with an R² of 0.859. The maximum adsorption for TEMPO-CNF was slightly lower than that of NOCNF when comparing samples with similar carboxylate content. This may be related to the different processes used to extract CNF. The morphology of NOCNF and TEMPO-CNF was noticeably different, with the latter having a greater fiber aspect ratio.

All adsorption results by both CNF samples also fit well by the Freundlich isotherm models with R² values between 0.904-0.972 (Table 6). The corresponding isotherm plots are shown in FIG. 16.

TABLE 6
Freundlich isotherm fitting results for varying cellulose
nanofibers (CNF) summarized from FIG. 17.
NOCNF

| Sample | 0.2 mmol/g | 0.8 mmol/g | 1.1 mmol/g |
|---|---|---|---|
| K_{F} | −0.486 | −0.184 | 0.449 |
| n | 1.54 | 1.68 | 1.93 |
| R² | 0.932 | 0.958 | 0.904 |

TEMPO-CNF

| Sample | 0.86 mmol/g | 1.14 mmol/g | 1.20 mmol/g |
|---|---|---|---|
| K_{F} | −0.662 | −0.686 | −0.402 |
| n | 1.20 | 1.25 | 1.40 |
| R² | 0.951 | 0.972 | 0.941 |

The Freundlich isotherm model represents the multi-layer adsorption process, where the adsorbate can adsorb onto another layer of adsorbate.

### Effect of pH on Zeta Potential and Adsorption Capacity of NOCNF

FIG. 15 shows how changing the pH of NOCNF effects zeta potential and adsorption capacity. The zeta potential of NOCNF became less negative as the pH became increasingly acidic with a corresponding change in zeta potential from −107 mV to −60 mV. Because the carboxylate group in NOCNF is a weak acid, it is susceptible to changes in pH. The highest adsorption capacity was recorded at a slightly acidic-neutral pH of 6. In this environment, the carboxylic ion functional groups should exist around their pKa and be able to exchange counter ions freely. Ammonium with a pKa value of 9.25, will exist at the ammonium form at pH=6, but will shift towards the ammonia form as the pH value is increased. At a pH of 8, a small amount of ammonium could be in equilibrium with ammonia, a neutral molecule that is less likely to be adsorbed onto NOCNF. Likewise, because the carboxylate ion is the conjugate base of a weak acid, it is more selective for protons than it is for ammonium.

### Effect of Adsorbate on Zeta Potential

FIG. 15 also displays the effect of adding ammonium solution on the zeta potential of NOCNF. Adsorption capacity was plotted as a comparison. As the adsorption capacity increased, zeta potential was relatively unchanged. As adsorption capacity reached its limit, the zeta potential switched from a negative value to a positive value, and the molar ratio of ammonium over carboxylate ions approached one. This indicates that the limitation of the adsorption capacity is the number the carboxylate groups, and the loading of ammonium onto the functional groups is 1:1. Furthermore, a rapid change in zeta potential was observed, as carboxylate ion groups became saturated.

### NOCNF in Column Filtration

1.0 grams of freeze dried NOCNF were placed into a column and 20 ppm ammonium solution was poured through and collected at an average flux of 0.1 ml/min. The effluent solution decreased over the course of 15 minutes from 19.7 ppm to 15.7 ppm. The effluent solution then gradually decreased to 14.1 ppm by 67 minutes. The gradual decrease in concentration is explained by unequal solution retention by the NOCNF. When solution was first introduced to a dry column, there was less contact time with the column. As the solution was allowed to permeate the solid, ammonium had adequate time to adsorb onto NOCNF.

NOCNF produced herein (NOCNF 1.1) demonstrated a relatively good ammonium adsorption of 22.7 mg/g.

A maximum adsorption capacity of 42.7 mg/g was observed for a hydrogel prepared using polyvinyl alcohol (PVA), acrylic acid and tourmaline. While some of the listed materials are either chemically unsustainable, non-biodegradable, somewhat toxic, or have lower efficiencies, the NOCNF is biodegradable, non-toxic, has good adsorption efficiency, and requires simple chemical processing.

### Demonstration of Ammonium-Loaded NOCNF as a Fertilizer

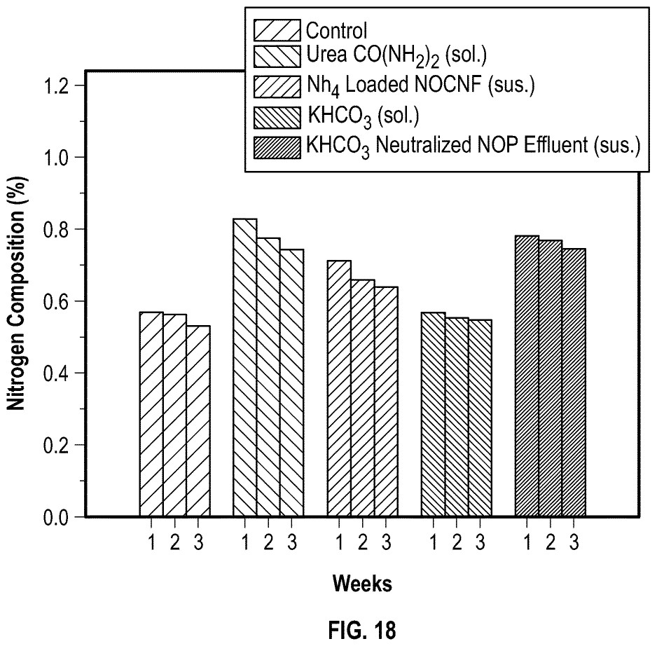

FIGS. 18 through 20 show the effects of treated soil type on the nitrogen composition in the soil, roots, stems, and leaves, and the mass of roots, stems, and leaves of soybean over three weeks. Five different soil types were tested. The soils included the control, and those treated by urea, ammonium-loaded NOCNF, potassium bicarbonate, and NOP effluent. The NOP effluent was collected from reactions of NOCNF 0.8. The effluent was then neutralized to pH 6-7 with potassium bicarbonate, then oven dried at 50° C. for 72 hours. The control consisted of plain soil. Urea was used as a comparison to a typical nitrogen fertilizer.

Ammonium-loaded NOCNF was a demonstration of how the spent NOCNF could be used after ammonium remediation. The centrifuged ammonium-loaded NOCNF had an elemental nitrogen composition of 6.1% by mass, which reflected some of the excess ammonium chloride solution which could not be easily separated. NOP effluent was a demonstration of how the nitrogen rich effluent from the NOP can be utilized. The NOP effluent had an elemental nitrogen composition of 7.4% and potassium content of 16.25%. Because the NOP effluent was neutralized with potassium bicarbonate, a treatment of just potassium bicarbonate was also studied.

Nitrogen composition in soil indicated a gradual decrease in elemental nitrogen content for all soils over time. As expected, the nitrogen composition in soils not treated with nitrogen, i.e., the control and potassium bicarbonate, had relatively less nitrogen at week 1. This is a reflection of not having any additional nitrogen added to the soil, and reflected the nitrogen already present in the soil. Over an additional two weeks, the decrease in nitrogen content was small, likely because there was not any added nitrogen. The nitrogen present in the control and potassium bicarbonate is likely fixed because this nitrogen had an extended amount of time to reach a stable and fixed state.

After week 1, soil treated with urea had the greatest nitrogen composition. Urea is a neutral molecule, which hydrolyzes into ammonium and carbamate ions, through enzymes in the soil. Enzymes, such as urease, tend to be abundant in natural soils. The carbamate ion then decomposes into ammonium and bicarbonate. This process is on the order of days. In contrast, the adsorption of ions such as calcium and magnesium onto carboxylate sites on the cellulose surface, which are exchanged for the original ammonium counter ion, can occur within seconds. This can explain why the nitrogen content in ammonium-loaded NOCNF was the lowest of the nitrogen containing samples. Ammonium was quickly displaced, then either leached or taken in by the plants. Ammonium likely was not primarily fixed, as this would still be reflected in the elemental nitrogen analysis. The nitrogen composition in the NOP effluent soil was greater than that of the ammonium-loaded NOCNF. The nitrogen composition of soil treated with the NOP effluent compared to soil treated with urea was slightly lower at week 1 and slightly higher at week 3.

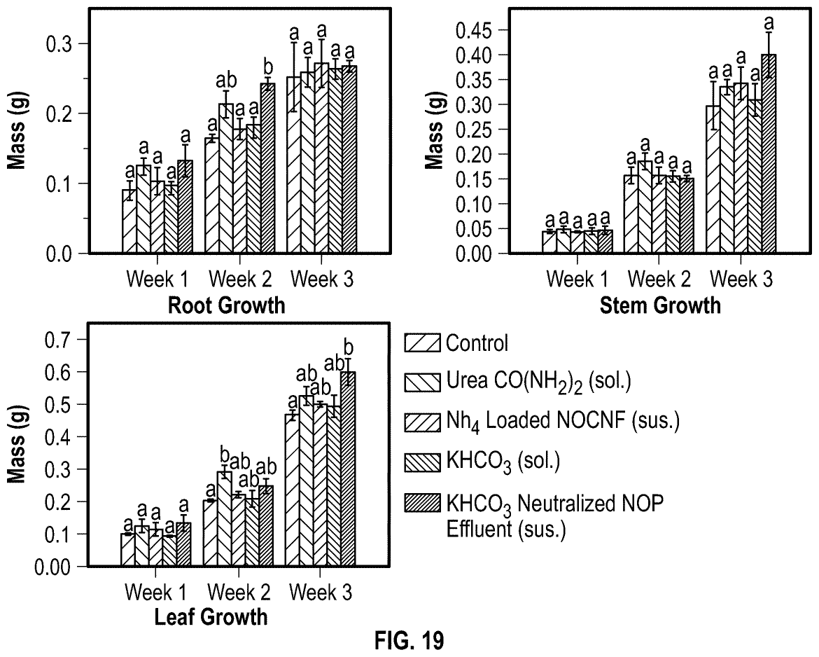

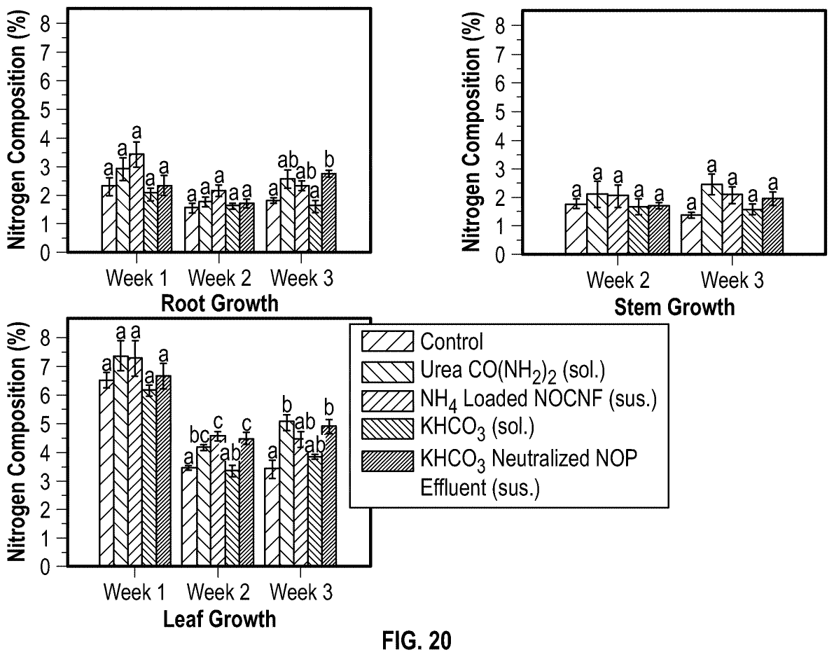

FIG. 19 and FIG. 20 show the results of statistically evaluated soils using a one-way analysis of variance (ANOVA), followed by a pair wise t-test assuming unequal variances with a Bonferroni adjustment. The number of pair wise t-tests were calculated by equation 4 below, where k represents the number of groups being compared.

$$tests = k \times \frac{( k - 1 )}{2} \qquad ( 4 )$$

Because 5 different groups were being compared, the number of pair wise t-tests was equal to 10. The Bonferroni adjustment corrected the alpha value, and was calculated by taking the original alpha value of 0.05 divided by the number of t-tests conducted. In this study, the alpha value used was 0.005.

In FIG. 19, the mass of the roots, stems and leaves increased over three weeks. This was expected, as the mass should not decrease unless the plants are stressed in some way. Because the testing period was only three weeks, factors such as nutrient depletion were not significant. Furthermore, none of the soil treatments were apparently acutely toxic towards the plants, given the steady and positive growth. FIG. 19 graphs were separated by root, stem and leaf growth. The mass of each respective component was compared over time. The relative growth was compared by the calculated mean values. However, it is more relevant to compare the statistical differences between soils. This difference is indicated by lower case letters above each soil type. Soils which share the same letter are not statistically different from each other.

Root masses at week 1 were all comparable. The germination process was likely still a major influence of relative root growth at week 1. Early root growth was largely influenced by the seed itself. Accessibility to nutrients was dependent on a plants root network, but the seeds started with some nutrient reserves. Factors such as soil moisture tend to affect germination more strongly. By week 2, the root growth from NOP effluent was greater than the control, ammonium-loaded NOCNF, and potassium bicarbonate. Soil treated with urea was designated with ab, indicating it was statistically comparable with a and with b. Because NOP effluent contains nitrogen and potassium, both being essential nutrients for plants, increased plant growth expressed in the mass of the roots was expected. At week 3, root masses were all comparable.

Stem masses in all soil samples were also comparable for each respective week.

Finally, it was observed that leaf masses were comparable at week 1. By week 2, leaf growth in urea treated soil was higher than the control sample. By week 3, leaf mass was comparable to the control, but the leaf mass from NOP effluent treated soil was greater than the control. NOP effluent had a leaf mass of 0.60 grams while the control had a leaf mass of 0.47 grams.

In FIG. 20, the nitrogen composition of roots, stems, and leaves are plotted over time in weeks. Root nitrogen compositions in weeks 1 and 2 were all comparable. By week 3, nitrogen composition in NOP effluent was greater than the control, with nitrogen compositions of 2.75 and 1.80%, respectively.

Stem nitrogen composition for week 1 was not measurable, because 0.1 grams of sample was required for analysis. Furthermore, nitrogen levels were comparable for all samples for their respective time periods.

Nitrogen is used in plants to create chlorophyll, a molecule used for photosynthesis, and more commonly expressed in leaves. This was observed in this study, as demonstrated by average nitrogen composition in the control soil at week 3 is 3.3, 2.7, and 1.2% for leaves, roots, and stems, respectively. In FIG. 20, nitrogen composition of leaves at week 1 was the highest, and comparable for all soils. At week 2, urea, ammonium-loaded NOCNF, and NOP effluent soils had greater nitrogen compositions than the control. At week 3, only urea and NOP effluent, with nitrogen compositions of 5.02 and 4.87% respectively, expressed greater nitrogen composition than the control of 3.34%.

### Environmental Implications

In summary, the feasibility of a sustainably sourced, low-cost, plant-derived, and negatively charged nanocellulose to capture ammonium in the nitrogen cycle via adsorption and column filtration is demonstrated. In this study, the motivation of targeting the removal of ammonium before nitrification and de-nitrification can short circuit the nitrogen cycle, which may alleviate environmental concerns such as eutrophication, acid rain, and leaching. Common wastewater treatment plants utilize a multi-step process of nitrifying bacteria to oxidize ammonium to nitrite and nitrate, then ultimately to nitrogen gases. The above Examples demonstrate the one step procedure for the remediation of ammonium using NOCNF. NOCNF tested at different relative concentrations of ammonium, pH, and degrees of oxidation illustrate relatively good ammonium removal at a neutral pH. The ammonium adsorption results fit the Langmuir isotherm modeling, indicating the monolayer adsorption process. Furthermore, this mechanism is confirmed by the ammonium adsorption results that is stoichiometrically related to carboxylate groups at a 1:1 molar ratio (at this ratio, the zeta potential is no longer negative). It is evident that NOCNF can be effectively applied in treating ammonium containing wastewater such as municipal waste, source separated urea, and fisheries. This ammonium-loaded NOCNF was further proven as nutrient rich and biodegradable fertilizer, where a comparable fertilization study was carried out in early plant growth also including commercial standard such as urea.

Table 7 below summarizes the ammonium remediation data obtained for the NOCNF produced in accordance with the Examples.

TABLE 7
Ammonium (NH₄⁺) remediation data.

| | | | | | | | | | |
|---|---|---|---|---|---|---|---|---|---|
| | Equilibrium | | Conc. of NOCNF | | | | Quantity | | |
| Initial Conc. | Conc. of | Conc. of Water + NH₄⁺ | (0.0910 wt. %) + | Difference | | NH₄⁺ | of | | |
| of NH₄⁺ | NH₄⁺ (ppm) | Solution 1:1 | NH₄⁺ Solution 1:1 | in Conc. | Efficiency | Removed | NOCNF | Qₑ | |
| (ppm) | Ce | (ppm) | (1.5 ml each) (ppm) | (ppm) | (%) | (mg) | (grams) | (mg/g) | Ce/Qe |

NOCNF 1.1

| | | | | | | | | | |
|---|---|---|---|---|---|---|---|---|---|
| 5 | 2.5 | 3.2 | 1.7 | 1.5 | 46.9 | 0.0045 | 0.00136 | 3.3 | 0.76 |
| 8.75 | 4.375 | 6.3 | 3.5 | 2.8 | 44.4 | 0.0084 | 0.00136 | 6.2 | 0.71 |
| 12.5 | 6.25 | 10.3 | 6.3 | 4.0 | 38.8 | 0.012 | 0.00136 | 8.8 | 0.71 |
| 25 | 12.5 | 21.1 | 15.5 | 5.6 | 26.5 | 0.017 | 0.00136 | 12 | 1.01 |
| 37.5 | 18.75 | 31.7 | 24.9 | 6.8 | 21.5 | 0.020 | 0.00136 | 15 | 1.25 |
| 50 | 25 | 41.3 | 33.9 | 7.4 | 17.9 | 0.022 | 0.001362 | 16 | 1.53 |
| 87.5 | 43.75 | 61.2 | 52.9 | 8.3 | 13.6 | 0.025 | 0.001362 | 18 | 2.40 |
| 125 | 62.5 | 74 | 65.3 | 8.7 | 11.8 | 0.026 | 0.001362 | 19 | 3.27 |

NOCNF 0.8

| | | | Conc. of NOCNF | | | | | | |
|---|---|---|---|---|---|---|---|---|---|
| | | | (0.123 wt. %) + | | | | | | |
| | | | NH₄⁺ | | | | | | |
| | | | Solution 1:1 (5 ml each) | | | | | | |
| | | | (ppm) | | | | | | |
| 5 | 2.5 | 2.7 | 1.3 | 1.4 | 51.9 | 0.014 | 0.00615 | 2.3 | 1.1 |
| 8.75 | 4.375 | 4.3 | 2.2 | 2.1 | 48.8 | 0.021 | 0.00615 | 3.4 | 1.3 |
| 12.5 | 6.25 | 6.9 | 3.9 | 3.0 | 43.5 | 0.030 | 0.00615 | 4.9 | 1.3 |
| 25 | 12.5 | 13.6 | 8.8 | 4.8 | 35.3 | 0.048 | 0.00615 | 7.8 | 1.6 |
| 37.5 | 18.75 | 20.8 | 14.3 | 6.5 | 31.2 | 0.065 | 0.00615 | 11 | 1.77 |
| 50 | 25 | 28.1 | 21.1 | 7.0 | 24.9 | 0.070 | 0.006150 | 11 | 2.20 |
| 87.5 | 43.75 | 42.7 | 34.4 | 8.3 | 19.4 | 0.083 | 0.006150 | 14 | 3.24 |
| 125 | 62.5 | 65.6 | 56.6 | 9.0 | 13.7 | 0.090 | 0.006150 | 15 | 4.27 |

NOCNF 0.2

| | | | Conc. of NOCNF | | | | | | |
|---|---|---|---|---|---|---|---|---|---|
| | | | (0.592 wt. %) + | | | | | | |
| | | | NH₄⁺ | | | | | | |
| | | | Solution 1:1 (2.5 ml each) | | | | | | |
| | | | (ppm) | | | | | | |
| 5 | 2.5 | 3.3 | 2.0 | 1.3 | 39.4 | 0.0065 | 0.0148 | 0.44 | 5.7 |
| 8.75 | 4.375 | 6.1 | 3.5 | 2.6 | 42.6 | 0.013 | 0.0148 | 0.88 | 5.0 |
| 12.5 | 6.25 | 8.5 | 5.0 | 3.5 | 41.2 | 0.018 | 0.0148 | 1.2 | 5.3 |
| 25 | 12.5 | 16.6 | 10.3 | 6.3 | 38.0 | 0.032 | 0.0148 | 2.1 | 5.9 |
| 37.5 | 18.75 | 24.1 | 16.6 | 7.5 | 31.1 | 0.038 | 0.0148 | 2.5 | 7.4 |
| 50 | 25 | 30.6 | 21.8 | 8.8 | 28.8 | 0.044 | 0.01480 | 3.0 | 8.4 |
| 87.5 | 43.75 | 47.0 | 36.4 | 10.6 | 22.6 | 0.0530 | 0.01480 | 3.58 | 12 |
| 125 | 62.5 | 61.1 | 50.5 | 10.6 | 17.3 | 0.0530 | 0.01480 | 3.58 | 17 |

| | | | | | | | | |
|---|---|---|---|---|---|---|---|---|
| | | | Conc. of | | | | | |
| | | | TEMPO-CNF | | | | Quantity | |
| Initial Conc. | Equilibrium Conc. | Conc. of | (0.751 wt. %) + NH₄⁺ | Difference | | NH₄⁺ | of | |
| of NH₄⁺ | of NH₄⁺ | Water + NH₄⁺ | Solution 1:1 | in Conc. | Efficiency | Removed | NOCNF | Qₑ |
| (ppm) | (ppm) Cₑ | Solution 1:1 (ppm) | (3 ml each) (ppm) | (ppm) | (%) | (mg) | (grams) | (mg/g) |

TEMPO-CNF 0.86

| | | | | | | | | |
|---|---|---|---|---|---|---|---|---|
| 5 | 2.5 | 2.0 | 0.6 | 1.4 | 70.0 | 0.0084 | 0.0225 | 0.37 |
| 8.75 | 4.375 | 3.7 | 1.2 | 2.5 | 67.6 | 0.015 | 0.0225 | 0.67 |
| 12.5 | 6.25 | 5.4 | 1.7 | 3.7 | 68.5 | 0.022 | 0.0225 | 0.99 |
| 25 | 12.5 | 10.9 | 3.8 | 7.1 | 65.1 | 0.043 | 0.0225 | 1.9 |
| 37.5 | 18.75 | 19.5 | 7.9 | 11.6 | 59.5 | 0.0696 | 0.0225 | 3.09 |
| 50 | 25 | 27.5 | 11.2 | 16.3 | 59.3 | 0.0978 | 0.0225 | 4.34 |
| 87.5 | 43.75 | 45.6 | 21.2 | 24.4 | 53.5 | 0.146 | 0.0225 | 6.50 |
| 125 | 62.5 | 36.6 | 12.3 | 24.3 | 66.4 | 0.146 | 0.0225 | 6.47 |
| 250 | 125 | 58.9 | 29.9 | 29.0 | 49.2 | 0.174 | 0.0225 | 7.73 |

Concentration
of TEMPO-CNF
(0.765 wt. %) + NH₄⁺
Solution 1:1 (4 ml each)
(ppm)

TEMPO-CNF 1.14

| 5 | 2.5 | 1.9 | 0.6 | 1.3 | 68.4 | 0.010 | 0.0306 | 0.34 |
|---|---|---|---|---|---|---|---|---|
| 8.75 | 4.375 | 3.4 | 1.2 | 2.2 | 64.7 | 0.018 | 0.0306 | 0.58 |
| 12.5 | 6.25 | 5.0 | 1.7 | 3.3 | 65.7 | 0.026 | 0.0306 | 0.86 |
| 25 | 12.5 | 10.6 | 3.6 | 7.0 | 66.0 | 0.056 | 0.0306 | 1.8 |
| 37.5 | 18.75 | 14.4 | 5.5 | 8.9 | 61.8 | 0.071 | 0.0306 | 2.3 |
| 50 | 25 | 19.2 | 6.9 | 12.3 | 64.1 | 0.0984 | 0.0306 | 3.22 |
| 87.5 | 43.75 | 34.1 | 13.4 | 20.7 | 60.7 | 0.166 | 0.0306 | 5.41 |
| 125 | 62.5 | 46.8 | 20.7 | 26.1 | 55.8 | 0.209 | 0.0306 | 6.82 |
| 250 | 125 | 86.5 | 47.8 | 38.7 | 44.7 | 0.310 | 0.0306 | 10.1 |
| 375 | 187.5 | 112.2 | 69.4 | 42.8 | 38.1 | 0.342 | 0.0306 | 11.1 |
| 500 | 250 | 129.1 | 83.9 | 45.2 | 35.0 | 0.362 | 0.0306 | 11.8 |
| | | | Concentration | | | | | |
| | | | of TEMPO-CNF | | | | | |
| | | | (0.690 wt. %) + NH₄⁺ | | | | | |
| | | | Solution 1:1 (3 ml each) | | | | | |
| | | | (ppm) | | | | | |

TEMPO-CNF 1.20

| | | | | | | | | |
|---|---|---|---|---|---|---|---|---|
| 5 | 2.5 | 3 | 1.3 | 1.7 | 56.7 | 0.010 | 0.0207 | 0.49 |
| 8.75 | 4.375 | 6.1 | 2.3 | 3.8 | 62.3 | 0.023 | 0.0207 | 1.1 |
| 12.5 | 6.25 | 8.3 | 3.3 | 5.0 | 60.2 | 0.030 | 0.0207 | 1.4 |
| 25 | 12.5 | 16.3 | 6.4 | 9.9 | 60.7 | 0.059 | 0.0207 | 2.9 |
| 37.5 | 18.75 | 23.5 | 9.7 | 13.8 | 58.7 | 0.0828 | 0.0207 | 4.00 |
| 50 | 25 | 30.2 | 12.7 | 17.5 | 57.9 | 0.105 | 0.0207 | 5.07 |
| 87.5 | 43.75 | 48.2 | 22.1 | 26.1 | 54.1 | 0.157 | 0.0207 | 7.57 |
| 125 | 62.5 | 61.7 | 31.9 | 29.8 | 48.3 | 0.179 | 0.0207 | 8.64 |
| 250 | 125 | 101.5 | 59.5 | 42.0 | 41.4 | 0.252 | 0.0207 | 12.2 |
| 500 | 250 | 148.0 | 103.9 | 44.1 | 29.8 | 0.265 | 0.0207 | 12.8 |

Experiments with stronger oxidizing conditions generated highly charged fibers, which can be fibrillated into nanofibers using a high-pressure homogenizer. When acid groups are converted to carboxylate ion groups, cellulose nanofibers form a stable colloidal suspension which can adsorb cations such as ammonium, or crosslink with multivalent cations, such as aluminum, to form stable gels for the removal of fluoride anions.

### Example 17

Oxidized NOP celluloses often include a mixture of macrofibers/microfibers or nanofibers with varying degree of oxidation (i.e., the amount of carboxylate groups on cellulose fibers). Macrofibers or microfibers having the least amount of carboxylate groups have a tendency to settle or precipitate from solution.

Alternatively, the oxidized NOP fibers often aggregate when carboxylate groups are protonated at an acidic pH<5.0 (the pKa of carboxylic acids is ~5). Upon adjusting to a pH of 6.55 with ammonium hydroxide (NH₄OH), we observed a colloidally stable oxidized NOP cellulose suspension. Without wishing to be bound by any theory, it is believed this is because of deprotonation of the carboxylate group due to strong repulsive forces between the fibers.

The oxidized cellulose fibers were prepared as described above in Example 3 (NOCNF 1.1) with a slight modification. 20 grams of jute was treated with 280 mL of 50% nitric acid (HNO₃) in a 4 L round bottom flask and sealed. After one hour, a solution comprised of 19.2 grams sodium nitrite (NaNO₂) dissolved in 40 mL DI water was added dropwise via addition funnel to the reaction flask. After addition of NaNO₂, the addition funnel was removed and the flask was sealed to react for a total reaction time of 9 hours. The pH of oxidized cellulose fibers (pH 2.5) was adjusted to pH 6.55 using 50% (v/v) ammonium hydroxide (NH₄OH) solution. In order to avoid using a homogenizer, a benchtop regular coffee grinder was used for preparing a suspension of highly viscous cellulose fibers.

The 80 mL of oxidized cellulose suspension (=2.5 Wt %) that was obtained was diluted with 40 mL of deionized water, and then blended using a regular coffee grinder for a period of time of about 3 minutes to about 6 minutes. After blending, a highly viscous suspension of 1.63 Wt %, including defibrillated oxidized cellulose macrofibers/microfibers and/or nanofibers, was obtained. Moreover, due to viscosity changes, numerous trapped air bubbles were observed in the suspension. These air bubbles, where the resulting suspension was used as a fertilizer, could facilitate the root growth of plants due to the increased amount of oxygen.

### Example 18

Hydrogels were prepared by combining 5 mL of 1.63 wt. % of CNF with 250 μL of 100 mM CaNO₃ solution and 500 μL of 100 mM CaNO₃ solution, respectively. It was observed that hydrogels were successfully formed and remained at the bottom of the vials for both samples. Additional hydrogels were prepared at a dilute CNF concentration of 0.84 wt. % upon adding 250 μL of 100 mM CaNO₃ solution and 500 μL of 100 mM CaNO₃ solution, respectively. It was observed that the hydrogels were also well formed at this lower CNF concentration. Interestingly, all the prepared hydrogels possessed air bubbles after blending as described above in Example 17.

### Example 19

Hydrogels prepared by homogenized CNF (sample names: T1 and T2) were prepared as follows. For the biomass, if particles were above 5 mm, they were passed through a grinder with a 2 mm grating. The ground sample was then placed in a round bottom flask along with a 1:14 ratio of biomass:50% HNO₃. The reaction flask was sealed and lowered into an oil bath kept at 50° C. for one hour. After one hour, an addition funnel containing a solution of 1:14 ratio of biomass:mmol NaNO₂ was added dropwise. After addition, the addition funnel was removed, and the flask was sealed to react for a total of 9 hours. When the reaction was completed, the product was separated via filtration and/or decantation and reaction effluent was collected separately from oxidized fibers. The fibers were then washed with DI water until a pH of 2.5 or above and stored until further use. Blended CNF (sample names: H2 and H3), were prepared for comparison. Hydrogels H2 and H3 were prepared by adding 0.84 Wt % of blended CNF at 650 μL of 200 mM CaNO3 and 1300 μL of 200 mM CaNO3, respectively. Hydrogels T₁ and T₂ were prepared by adding 0.93 Wt % of blended CNF with 650 μL of 200 mM CaNO3 and 1300 μL of 200 mM CaNO3, respectively.

Other than the slight difference of Wt % between H2 and H3, and T₁ and T₂, the pH of both systems was 6.55 (H2/H3) and 6.1 (T1/T2). It was observed that the hydrogels of both blended and homogenized CNF were obtained, whereas the overall stability of the H3 and T2 hydrogels was higher than what was observed for the H2 and T1 hydrogels.

While not wishing to be bound by any theory, it is believed the difference in stability was due to the higher concentration of CaNO₃ in H3 and T2, which could cross-link more fibers as compared with lower concentration of CaNO₃ (i.e., H2 and T1). The H3 and T2 hydrogels were capable of supporting nearly 25 grams of weight, while H2 and T1 hydrogels collapsed under that weight.

### Example 20

The oxidized NOP cellulose, after pH adjustment to 6.55 using NH₄OH (before blending), as described above in Example 17, was centrifuged at 3000 rpm for 15 minutes. This resulted in a clear supernatant possessing nanofibers and a precipitate of macrofibers and/or microfibers.

The precipitated fibers thus obtained were then combined with 5 mL acetone or deionized water, respectively. The two samples (precipitated fibers+water and precipitated fibers+acetone) were then oven dried at 60° C. for 2-4 days. It was observed that acetone accelerated the drying process of the fibers (completely dried within 2 days) as compared with fibers with water, where drying took almost 4-5 days.

The dried samples were then powdered by crushing and grinding with a mortar and pestle. Both powders were then dispersed in a water phase and sonicated for 2-3 hours followed by 10 minutes blending.

The above process resulted in stable and well dispersed oxidized NOP cellulose fibers, which were then used to prepare hydrogels as discussed below.

### Example 21

The fibers produced in Example 20 above were used to produce hydrogels. About 5 mL of blended (5 min vs. 10 min) acetone+water dried oxidized fibers (1.1 Wt. %) were combined with 250 μL of 200 mM CaNO₃ solution. Hydrogels formed as a result.

About 15 mL of a hydrogel was also prepared by adding the above fibers (acetone+water dried oxidized fibers i.e. 1.1 Wt. %) with 1.3 mL of 200 mM CaNO₃ solution. It was observed that the resulting hydrogels could support weights from 140 to 320 times higher than the weight of the hydrogel, which indicated superior stability.

Overall, it was found that the oxidized NOP celluloses could be dried, and it is possible to successfully redispersed them well in a water media which can be reused for stable hydrogel formulation. The drying process of such oxidized cellulose will significantly decrease the transport cost of the materials i.e., bringing them and preparing the hydrogel at point-of-use.

It will be understood that various modifications may be made to the embodiments disclosed herein. Therefore, the above description should not be construed as limiting, but merely as an exemplification of preferred embodiments. Those skilled in the art will envision other modifications within the scope and spirit of the present disclosure. Such modifications and variations are intended to come within the scope of the following claims.

What is claimed is:

1. A method comprising:
contacting a biowaste source with nitric acid;
optionally contacting the biowaste source and nitric acid with sodium nitrite;
heating the biowaste source, the nitric acid, and the optional sodium nitrite to a temperature of from about 25° C. to about 100° C. to form a gellable nanocellulose suspension; and
recovering the nanocellulose suspension.

2. The method of claim 1, wherein the nitric acid is in a solution at a concentration from about 30% to about 50%.

3. The method of claim 1, wherein the ratio of nitric acid in solution to the biowaste source is from about 10:1 to 1:1.

4. The method of claim 1, wherein the sodium nitrite is in a solution at a concentration of from about 15% to about 70% by weight.

5. The method of claim 1, wherein the ratio of sodium nitrite in solution to the biowaste source is from about 1:0.25 to 1:5.

6. The method of claim 1, wherein heating the biowaste source, the nitric acid, and the optional sodium nitrite for a period of time from about 1 hour to about 24 hours.

7. A fertilizer comprising the effluent or gellable suspension produced by the method of claim 1.

8. The method of claim 1, wherein the biowaste source includes cellulose.

9. The method of claim 8, wherein the gellable suspension includes carboxylated cellulose nanofibers.

10. The method of claim 1, further comprising contacting the biowaste source and nitric acid with sodium nitrite.

11. The method of claim 1, further comprising pre-treating the biowaste source with an alkaline solution prior to contacting the biowaste source with nitric acid.

12. The method of claim 11, wherein the alkaline solution is selected from KOH, NaOH, potassium phosphate, or combinations thereof.

13. The method of claim 11, wherein the alkaline solution has a pH from about 8 to about 14.

14. The method of claim 11, further comprising grinding biomass within the biowaste source prior to contacting the biowaste source with alkaline pre-treatment or nitric acid.

15. The method of claim 11, wherein the gellable nanocellulose suspension has a carboxylic acid content from about 0.1 mmol/g to about 3 mmol/g.

16. A fertilizer comprising the gellable nanocellulose suspension produced by the method of claim 11.
